(19) United States
(12) Patent Application Publication
(10) Pub. No.: US 2016/0210021 A1
(43) Pub. Date: Jul. 21, 2016

(54) Computer-Implemented Tools for Exploring Event Sequences

(71) Applicant: Microsoft Technology Licensing, LLC, Redmond, WA (US)

(72) Inventors: Emanuel Albert Errol Zgraggen, Providence, RI (US); Steven M. Drucker, Bellevue, WA (US); Danyel A. Fisher, Seattle, WA (US); Robert A. DeLine, Seattle, WA (US)

(21) Appl. No.: 14/601,255

(22) Filed: Jan. 21, 2015

(51) Int. Cl. G06F 3/0484; G06F 9/54; G06F 3/01

(52) U.S. Cl. CPC G06F 3/04842; G06F 3/017; G06F 9/542

(57) ABSTRACT

Functionality is described herein for allowing an investigating user to explore event sequences. The functionality constructs an expression in a pattern-matching language in response to the user's interaction with a user interface presentation. The functionality then compares the specified expression against one or more event sequences to find portions of the event sequences that match the expression, if any. The comparing operation yields matching sequence information. The functionality then generates and displays output information based on the matching sequence information. In one case, the expression is a regular expression.

### BACKGROUND

Users sometimes encounter a need to investigate events that have occurred within a particular environment. For example, a test engineer may wish to explore a sequence of events produced by a computer system to determine whether the computer system is operating in a normal or anomalous manner. In another scenario, a hospital administrator may wish to explore events that describe the care given to patients over a span of time. The user may face numerous technical challenges in performing the above task. These difficulties ensue, in part, from the lack of user-friendly tools for finding event patterns of interest within a corpus of event data, and then meaningfully interpreting those event patterns; such challenges are compounded by the typically complex and voluminous nature of the event data itself.

### SUMMARY

Computer-implemented functionality is described herein for exploring sequences of events (“event sequences”), and extracting meaningful information from the event sequences. In one manner of operation, the functionality receives input information in response to interaction by at least one user with a user interface presentation provided by a display output mechanism. The functionality then defines a node structure having one or more nodes based an interpretation of the input information, and displays a visual representation of the node structure on the user interface presentation. The node structure is associated with an expression in a pattern-matching language. The functionality then compares the expression against one or more event sequences to find portions of the event sequence(s) that match the expression, to provide matching sequence information. The functionality then generates output information based on the matching sequence information and displays a visual representation of the output information on the user interface presentation.

According to one illustrative aspect, each node in the node structure corresponds to a component of the expression. Further, each component is expressed using a vocabulary that is made up of a set of different possible event-related occurrences. According to one illustration implementation, the expression is a regular expression.

According to one effect, an investigating user can use the functionality to express an event pattern of interest in visual fashion, e.g., by using the functionality to successively creates the nodes of the node structure. This technical feature increases the speed and ease at which the investigating user may specify event patterns. Further, this technical feature enables even novice investigating users without significant (or any) programming experience to successfully use the functionality to create event patterns. Further, the functionality provides useful visualizations for conveying the matching sequence information. This technical feature increases the investigating user's insight into the nature of the original event sequences. Still other useful effects are set forth below.

The functionality (and/or a user) can perform any type of actions on the basis of the analysis provided by the functionality. For instance, such actions can include improving the performance of a system on the basis of the insight gained through the use of the functionality.

The above approach can be manifested in various types of systems, devices, components, methods, computer readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of an environment in which a user may explore event sequences using a sequence exploration module (SEM).

FIG. 2 shows one structure for organizing event data in event sequences.

FIG. 3 shows an example of event sequences that use the structure of FIG. 2.

FIG. 4 illustrates a match between an expression and a portion of an event sequence.

FIG. 5 shows one implementation of the SEM of FIG. 1.

FIG. 6 shows computing equipment that can be used to implement the SEM of FIG. 5.

FIG. 7 shows different node structures and their corresponding regular expressions. Each node structure includes one or more nodes.

FIG. 8 shows a node structure that includes two parallel node branches.

FIG. 9 shows another node structure that includes two parallel node branches.

FIG. 10 shows one technique by which the SEM of FIG. 5 can create a new node in response to an instruction from the user, and then invoke a first-level visualization of output information associated with that new node.

FIG. 11 shows a technique by which the SEM can invoke a second-level visualization of output information associated with the node of FIG. 10; the second-level visualization is more detailed compared to the first-level visualization.

FIG. 12 shows a visualization of output information that presents matching events with respect to the end users associated with the matching events.

FIG. 13 shows a visualization of output information that presents matching events as a function of the time of occurrence of matching events.

FIG. 14 shows one technique by which the SEM can create a new node, e.g., in response to a user's selection of an attribute within the visualization of FIG. 11.

FIG. 15 shows another way by which the SEM can create a new node, compared to the technique of FIG. 14.

FIG. 16 shows one technique by which the SEM can connect the node created in FIG. 10 with the node created in FIG. 14 or FIG. 15 in response to an instruction from the user. FIG. 16 also shows a visualization of output information associated with the node created via FIG. 10.

FIG. 17 shows one technique by which the SEM may switch the left-to-right ordering of two nodes in response to an instruction from the user.

FIG. 18 shows an example in which the SEM creates a node structure having five nodes in response to instructions from the user, organized in two parallel node branches.

FIGS. 19-21 collectively show an example by which the SEM binds attributes between two nodes in a node structure in response to an instruction from the user.

FIG. 22 is a process which describes one manner of operation of the SEM of FIG. 5.

FIG. 23 shows illustrative computing functionality that can be used to implement any aspect of the features shown in the foregoing drawings.

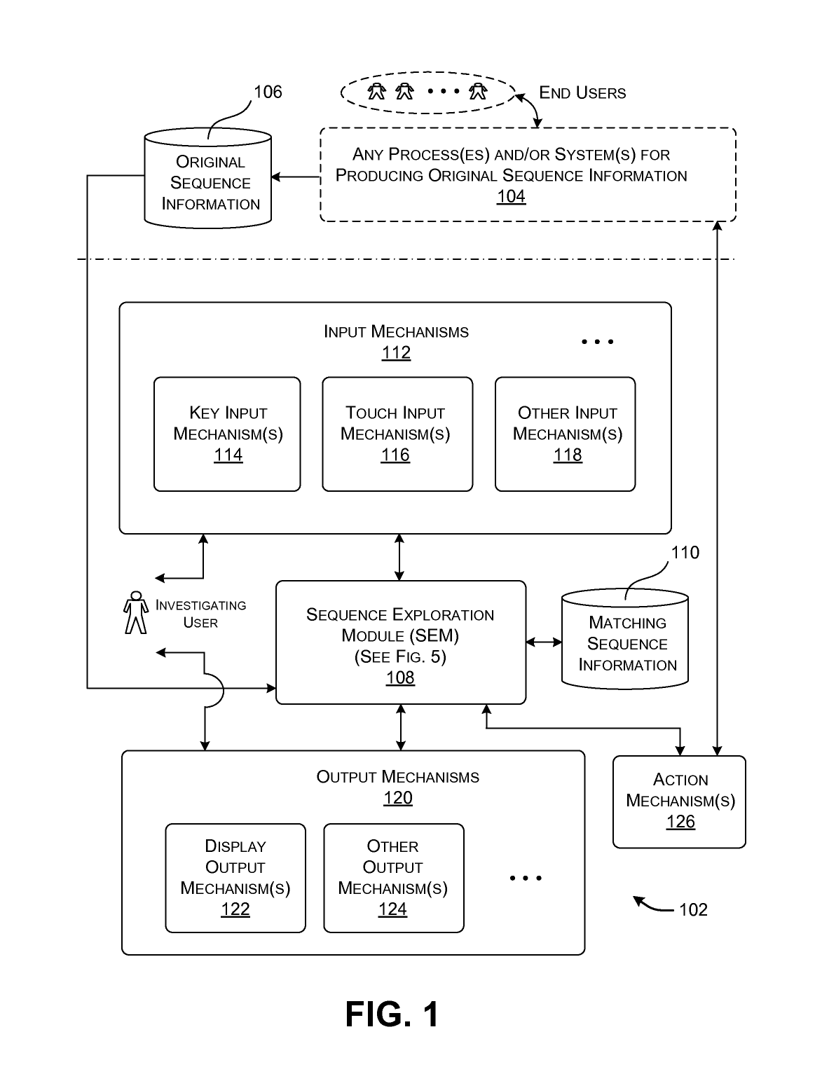

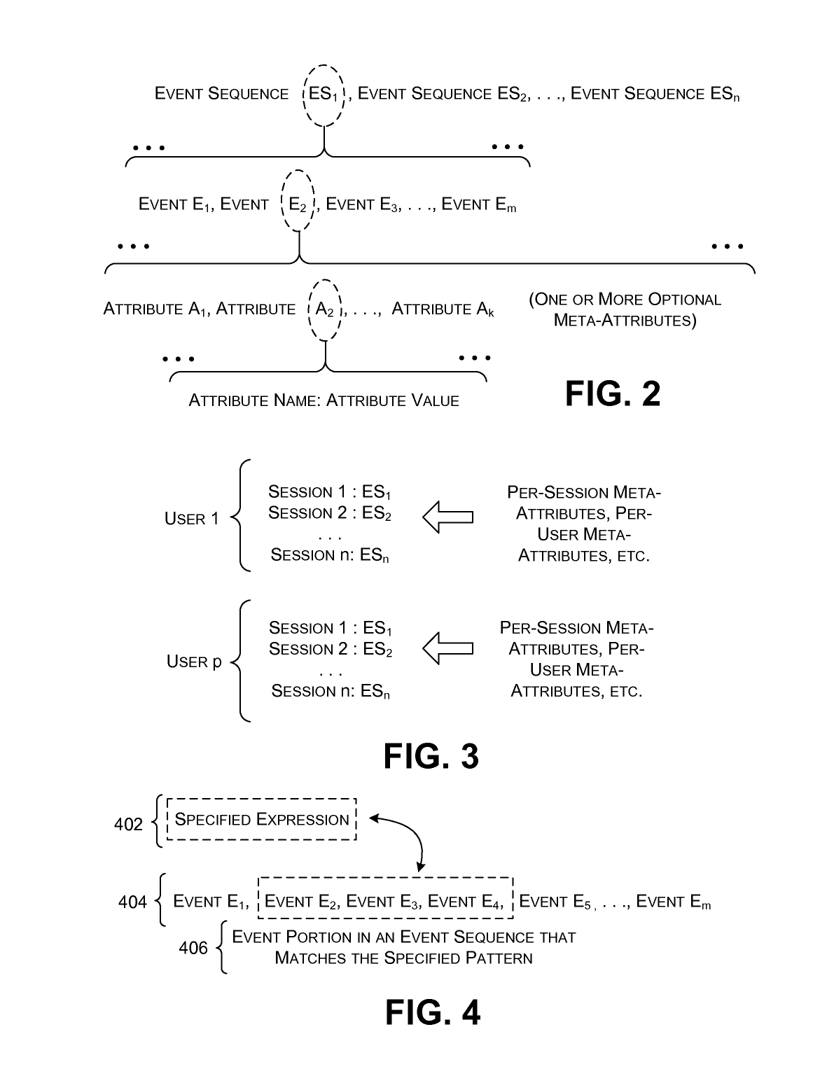

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes illustrative functionality for investigating event sequences. Section B sets forth illustrative methods which explain the operation of the functionality of Section A. Section C describes illustrative computing functionality that can be used to implement any aspect of the features described in Sections A and B.

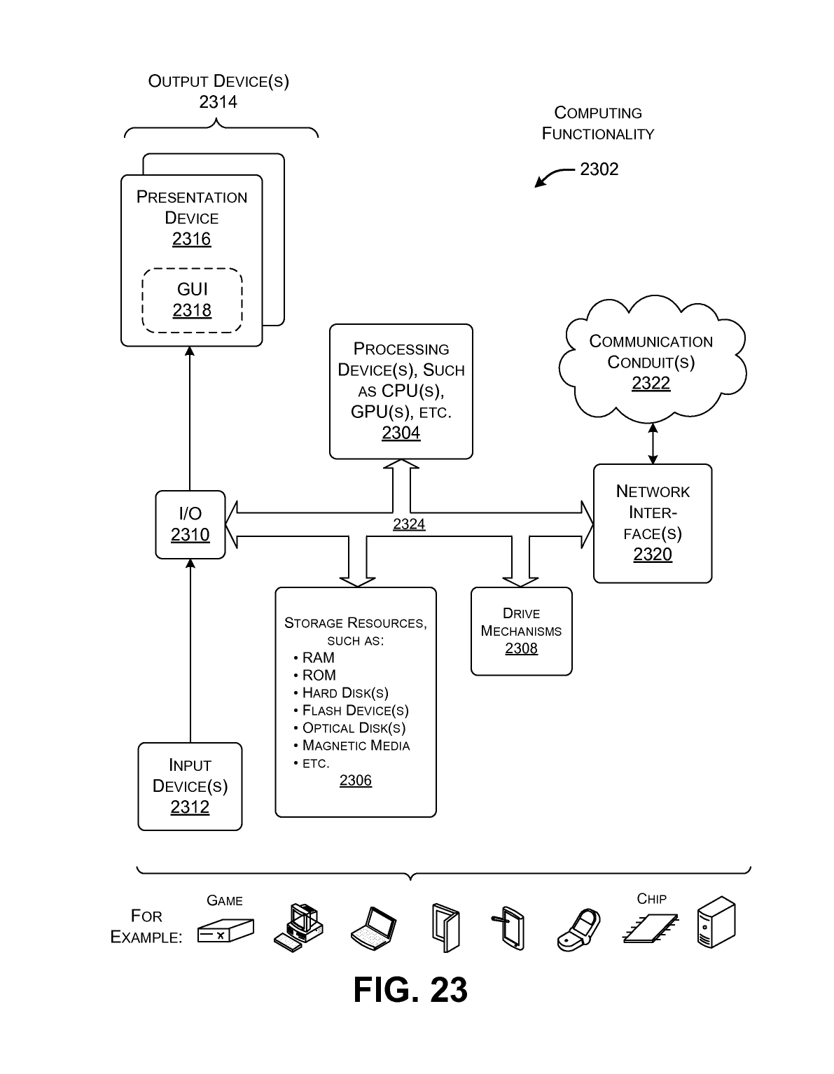

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software running on computer equipment, hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 23, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software running on computer equipment, hardware (e.g., chip-implemented logic functionality), etc., and/or any combination thereof.

As to terminology, the phrase “configured to” encompasses any way that any kind of physical and tangible functionality can be constructed to perform an identified operation. The functionality can be configured to perform an operation using, for instance, software running on computer equipment, hardware (e.g., chip-implemented logic functionality), etc., and/or any combination thereof.

The term “logic” encompasses any physical and tangible functionality for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative Computer-Implemented Functionality for Exploring Sequences

A.1. Overview

FIG. 1 shows an overview of an environment 102 that allows a user to explore event sequences. That user is referred to herein as an “investigating user,” mainly to distinguish that person from latter-referenced “end users.” More specifically, the explanation is framed in the context of a single user who interacts with the environment 102. But in other cases, two or more users may interact with the environment 102 in collaborative fashion (or in any other manner) to explore the event sequences.

Each event sequence includes a series of one or more events. An event corresponds to something that happens at a particular time. Each event may describe its occurrence using one more attributes. One such attribute identifies the time at which the event has occurred (or has commenced). FIGS. 2 and 3, described below, provide additional detail regarding the above-summarized structuring of event data.

However, in other examples, a sequence may correspond any other ordering of items of any type. For example, in another environment, an event sequence may refer to a collection of entities. The entities in a sequence may be associated with each other through any relationship(s) other than, or in addition to, a temporal ordering relationship. For example, the entities may be related to each other based on their positions in physical space, their ontological relatedness, their social relatedness, etc. Each entity may be described by one or more attributes. To facilitate explanation, however, the following description is framed mainly in the context of the exploration of event sequences, where a sequence refers to a temporal ordering of occurrences.

In the context of FIG. 1, any process(es) or system(s) 104 may produce one or more event sequences, for storage in a data store 106. (Each reference to a “data store” here may correspond to one or more physical underlying data storage mechanisms.) The sequence(s) are collectively and generically referred to herein as original sequence information. For example, a computer-implemented application may produce events that describe actions taken by one or more end users when interacting with the application. In another case, a computer system may produce events during its operation that correspond to performance metrics and/or error messages. In another case, a health-related system may store events that describe treatment provided to one or more patients. In another case, a meteorological system may record events that describe weather behavior, and so on. The above examples are cited by way of example, not limitation; many more applications and event-recording contexts are possible. To facilitate and simplify the explanation, the following examples will be mainly framed in the first-mentioned context, that is, for the case in which the event sequences refer to the behavior of one or more end users when interacting with some computer-implemented application or system.

An investigating user uses a sequence exploration module (SEM) 108 to investigate the event sequences in the original sequence information. By way of broad overview, the SEM 108 generates at least one expression in response to interaction with the user. The expression defines a pattern of events, expressed in a pattern-matching language, having any degree of specificity. More specifically, the SEM 108 may generate a node structure having one or more nodes using a visual interaction technique, e.g., in response to interaction by the investigating user with a user interface presentation. That is, the user enters instructions which specify the node(s) and the connections among the node(s), and the resultant node structure defines the expression. After creating an expression, the SEM 108 compares the expression with the original sequence information to identify those portions of the original sequence information (if any) which match the expression. Collectively, the identified portions are referred to herein as matching sequence information. A data store 110 may store the matching sequence information.

The SEM 108 also produces output information which conveys the matching sequence information using one or more visualizations described below. More specifically, the SEM 108 can produce the output information for the expression as a whole. In addition, the SEM 108 can produce output information for each node associated with the expression's node structure.

According to one effect, the investigating user can use the SEM 108 to express an event pattern of interest in visual fashion, e.g., by successively creating the nodes of node structure which represent the event pattern. This technical feature increases the speed and ease at which the investigating user may specify event patterns using the SEM 108. Further, this technical feature enables even novice investigating users without significant (or any) programming experience to successfully create event patterns using the SEM 108. More specifically, the SEM 108 may ultimately represent an expression, associated with an event pattern, using the formal constructs of a pattern-matching language. The investigating user, however, need not have expertise in the underlying pattern-matching language to successfully use the SEM 108. In other words, the investigating user need not know how to write the expression from “scratch” in a text-based manner.

Further, the SEM 108 provides useful visualizations for conveying the matching sequence information. This technical feature increases the investigating user's insight into the nature of the original event sequences. This technical feature also allows an investigating user to make meaningful revisions to his or her search strategy using the SEM 108. As another feature, the SEM 108 provides an interface technique that allows the investigating user to integrate and interleave the creation of a query with the visualization of the results for the query, which further facilitates the user's ability to efficiently produce meaningful matching results. Still other useful effects are set forth below.

The investigating user may provide input information to the SEM 108 via one or more input mechanisms 112. For example, the input mechanisms 112 may include one or more key input-type mechanisms 114 (referred to in the singular below), such as a keyboard, etc. The input mechanisms 112 may also include one or more touch input mechanisms 116 (referred to in the singular below), such as a capacitive touch input mechanism. The input mechanisms 112 may also include any other input mechanisms 118 for receiving input information, such a mouse device, a game controller, a free-space gesture recognition mechanism (e.g., based on the use of a depth camera, etc.), a tactile input mechanism, a voice-recognition-based input mechanism, and so on, or any combination thereof.

The SEM 108 may provide its output information on one or more output mechanisms 120. The output mechanisms 120 may include, for instance, one or more display output mechanisms 122 (referred to in the singular below), such as a liquid crystal display (LCD) display device, a cathode ray tube (CRT) display device, a projection display mechanism, and so on. At least one of the display output mechanism 122 may be integrated with the touch input mechanisms 116, to provide a touch-sensitive display mechanism. The output mechanisms 120 may also include one or more other output mechanisms 124, such as an audio output mechanism, a printer device, a three-dimensional model-generating mechanism, and so on.

One or more action-taking mechanisms 126 (referred to in the singular below) can perform any action(s) on the basis of analysis provided by the SEM 108. For example, assume that the event sequences in the original sequence information correspond to events that are generated by, or otherwise pertain to, a computer-implemented system. The action-taking mechanism 126 can modify the operation of the computer-implemented system on the basis of analysis performed by the SEM 108, e.g., by making a workflow more efficient (e.g., by eliminating or lessening a bottleneck condition), eliminating an error condition, and so on. In one case, the action-taking mechanism 126 can perform the above action(s) in response to an instruction from a user. In another case, the action-taking mechanism 126 can automatically take an action based on analysis performed by the SEM 108.

Advancing to FIG. 2, this figure shows one illustrative organization of event data, e.g., as provided by the original sequence information described above. The original sequence information includes one or more event sequences (e.g., event sequences ES₁, ES₂, . . . ESₙ). Each event sequence ESᵢ may include one or more events (e.g., events E₁, E₂, . . . Eₘ). Each event, in turn, is made up of one or more attributes (e.g., attributes A₁, A₂, . . . Aₖ). Finally, each attribute may be specified by an attribute-value pair. That is, the attribute-value pair specifies a name associated with the attribute, together with a particular value associated with that attribute. For example, an attribute may describe a checkout action by specifying the attribute-value pair “action=checkout”.

Some attributes are “local” in nature in that they apply to one specific event. For example, the attribute “query=Samsung S5” pertains to one specific event, e.g., corresponding to only one query submitted by the user at a particular time. Other attributes are referred to as meta-level attributes because each of them may apply to a group of one or more events. For example, a user-related meta-level attribute may describe an end user, and that end user may be associated with plural events. For instance, an end user's geographical location describes one user-related meta-level attribute. An end user's gender describes another user-related meta-level attribute, and so on. Another meta-level attribute may describe a session, and that session may be associated with plural events. For example, an end user's browser type describes a session-related meta-level attribute because it applies to all of the events in a session. The term “session,” in turn, can have different meanings in different contexts. In one example, a session may correspond to a user's interaction with a computer system that is demarcated by login and logout events. In another example, a session may correspond to a user's interaction with a computer application that is bounded by application activation and deactivation events, and so on.

Other implementations can use other data structures to represent the information in the event sequences, that is, compared to the example of FIG. 2. More generally stated, the event sequences may draw from any finite number of elements of different respective types. That list of finite elements may be extensible.

FIG. 3 provides one example of the general principles set forth above with respect to FIG. 2. In this case, each event sequence may correspond to occurrences that take place within a particular session, conducting by a particular end user, in which the end user interacts with a computer-implemented application. Over time, the end user's actions may generate plural such event sequences. One or more user-related meta-level attributes describe characteristics of the end user himself or herself. Each such user-related meta-level attribute applies to any event sequence associated with that end user. Similarly, one or more session-related meta-level attributes describe characteristics of a particular session, or two or more sessions. Each such session-related meta-level attribute applies to all events in a sequence.

To provide a specific example, one event may correspond to the event data: “4, 3, 8/1/14, 3:03, action=search, query=helmet.” The attribute “4” corresponds to an ID that identifies a session, which may be produced by a computer system when a user logs into the computer system or loads an application, etc. The attribute “3” corresponds to an ID that identifies an end user, which may also be produced by the computer system when a particular user logs into the computer system, e.g., after providing his or her credentials. The attribute “8/1/14” identifies the date on which the event occurred. The attribute “3:03” identifies the time at which the event commenced. The attribute “action=search” identifies the basic action performed by the end user. The attribute “query=helmet” further describes the action performed by the end user, e.g., by identifying the query term (“helmet”) submitted by the end user in performing a search. Note that, in some cases, the attribute name is implicit, e.g., as conveyed by the position of an attribute value within a set of attribute values. In other cases, the attribute name, e.g., as in “search,” is explicitly stated.

In one case, the process(es) and/or system(s) 104 may produce the original sequence information in the form that is described above and illustrated in FIGS. 2 and 3. In another case, the environment 102 may include a formatting engine (not shown) that transforms event data from an original from into a form that is compliant with the data structure described above with respect to FIGS. 2 and 3.

FIG. 4 summarizes a matching operation performed by the SEM 108 of FIG. 1. The SEM 108 operates by comparing a specified expression 402 with each event sequence, such as an illustrative event sequence 404. FIG. 4 further shows that a portion 406 of the event sequence 404 matches the expression 402. The portion 406 may encompass one or more events in the event sequence 404. Further, although not shown, the portion 406 may constitute one portion among one or more other matching portions. Further, the term “matching sequence information” refers to all of the portions, across all of the event sequences, which match the expression 402.

Overall, the SEM 108 constructs the expression 402 using a pattern-matching language. Generally, the expression 402 represents a finite-state machine (also referred to as a finite state automaton). For example, the SEM 108 may use a regular expression pattern-matching language to construct a regular expression.

Further, the regular expression may be expressed in terms of event-related occurrences. In other words, the SEM 108 constructs the regular expression using a language defined by a vocabulary of tokens, where the tokens in the vocabulary define possible event-related occurrences, rather than, or in addition to, a vocabulary defined by alphanumeric characters. For frame of reference, note that, in conventional application contexts, a user may use a regular expression to compare a pattern with some body of text, where the regular expression is constructed using a vocabulary of alphanumeric text characters. In contrast, in the present context, the SEM 108 uses a custom vocabulary that is constructed using its own event-level vocabulary. As such, the SEM 108 operates on a higher level of abstraction compared to other uses of regular expressions.

The vocabulary of event-related occurrences may specify events in any level of granularity. In one example, a token generally corresponds to a discrete event, encompassing all (or some) of the attribute-value pairs associated with that event. For example, one such token (or element) in the vocabulary may specify an event that occurs when an end user performs a search using a particular query. Another token in the vocabulary may specify that the end user views a particular product page. Another token in the vocabulary may specify that the end user places a particular product item in a shopping cart. Note that these event-related occurrences particularly pertain to an environment in which the event sequences describe the interaction of end users with a computer-implemented application. Other environments may rely on a vocabulary defined by other occurrences. For example, in a healthcare environment, one token in the vocabulary may specify a visit by a patient to a caregiver. Another token may specify a test performed on the patient by the caregiver, and so on. In general, it can be appreciated that the vocabulary (or universe) of possible event-related tokens may be much larger than the set of possible alphanumeric text characters. In other words, although the SEM 108 operates on a higher level of abstraction than text-based matching, it may use a much larger vocabulary than text-based matching.

More specifically, in one case, a token in the vocabulary includes its above-described local attribute-value pairs associated with an event (such as “action=search, query=dog”), but excludes the meta-level attributes associated with the event (such as “user ID=1234”). In this sense, the meta-level attributes are akin to formatting applied to textual characters which does not affect the matching performed on the textual characters. The timestamps define the ordering among event-related tokens in a particular sequence; in contrast, in text-based matching, the spatial placement of characters defines their ordering.

The SEM 108 may leverage the event-level matching described above to obtain more meaningful and reliable insights from the original sequence information. By comparison, the SEM 108 might be less successful in extracting information from the sequences by performing matching on a text-level granularity. For example, there may be more likelihood that an expression may inadvertently miss relevant event data if that expression is constructed in text-level tokens, rather than event-level tokens.

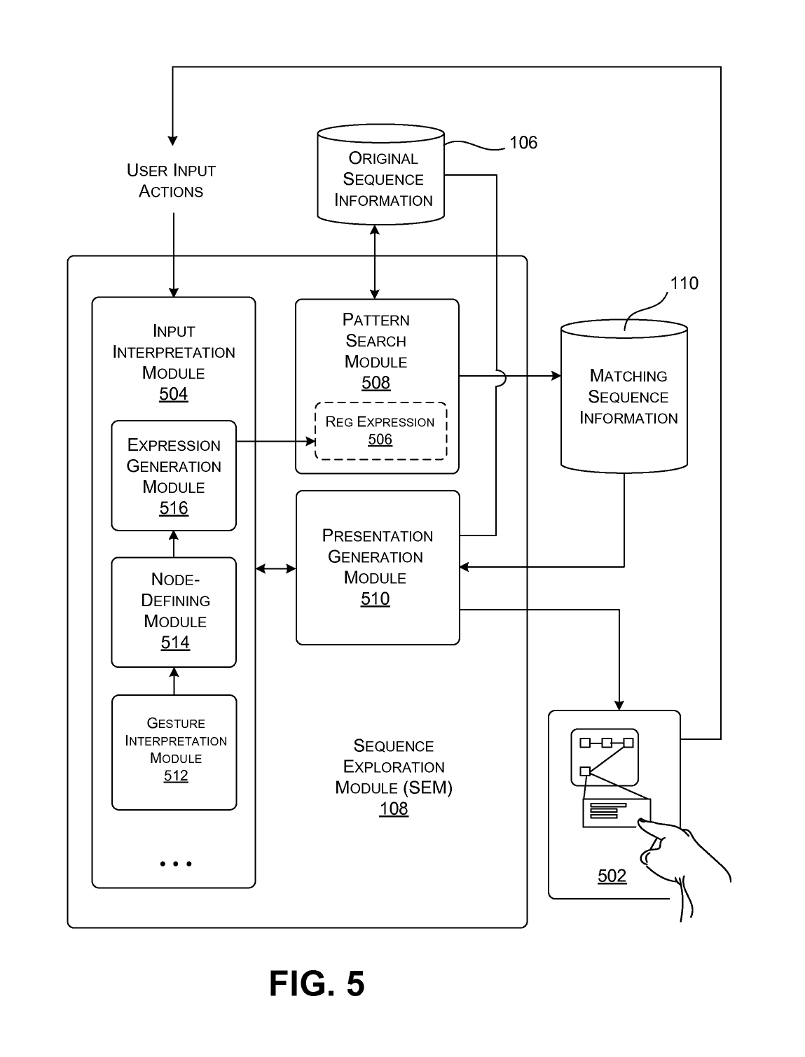

FIG. 5 shows one implementation of the sequence exploration module (SEM) 108, introduced above in the context of FIG. 1. In the example of FIG. 5, the SEM 108 provides a user interface presentation 502, which serves as the main vehicle through which the investigating user may interact with the SEM 108. In one example, the investigating user may provide input information to the SEM 108 via the touch-input mechanism 116, e.g., by using one or more hands (and/or other implements) to interact with the user interface presentation 502 to enter instructions, etc. Simultaneously, the SEM 108 provides output information to the investigating user via the user interface presentation 502. The next subsection provides detailed examples of different ways that the investigating user may interact with the user interface presentation 502. By way of overview, the user interface presentation 502 defines a two-dimensional canvas on which the user may specify the nodes of a node structure (to be described below) in a free-form manner. The user may also zoom and pan within the canvas.

The SEM 108 itself may include, or may be conceptualized as including, different components which perform different respective functions. An input interpretation module 504 interprets the input information provided by the investigating user via the user interface presentation 502. As a result of this interpretation, the input interpretation module 504 may produce an expression in a pattern-matching language. For example, the input interpretation module 504 may use a regular expression pattern-matching language to produce a regular expression 506. A pattern search module 508 then determines whether the pattern specified by the regular expression 506 matches any portions of the original sequence information (which is stored in the data store 106), to yield matching sequence information (which is stored in the data store 110).

A presentation generation module 510 produces the user interface presentation 502. More specifically, the presentation generation module 510 produces a visualization of a node structure associated with the regular expression 506, in response to the interaction with the user interface presentation 502. The node structure includes one or more nodes. The presentation generation module 510 also presents a visualization of output information; the output information, in turn, represents the matching sequence information provided in the data store 110. Again, the next subsection will provide additional explanation regarding the operation of the presentation generation module 510.

Now referring in greater detail to the input interpretation module 504, that component may include a gesture interpretation module 512 for interpreting gestures made by the investigating user in interacting with the user interface presentation 502. For example, the gesture interpretation module 512 may interpret touch input information that is received in response to the investigating user's touch-interaction with the user interface presentation 502. That is, at each instance, the gesture interpretation module 512 may compare the received input information provided by the input mechanisms 112 with predetermined triggering gesture patterns. If an instance of the input information matches one of the patterns associated with an associated gesture, then the gesture interpretation module 512 determines that the investigating user has performed that gesture. For example, as will be discussed below, the investigating user may performed a telltale gesture to create a new node, to link two nodes together, to change the positions of the nodes within a space defined by the user interface presentation 502, to activate a visualization of the output information, and so on.

A node-defining module 514 builds up a node structure in response to gestures detected by the gesture interpretation module 512. The node structure may include one or more nodes. An expression generation module 516 generates the regular expression 506 that represent the node structure. The expression generation module 516 may perform its function by using predetermined mapping rules to map the nodes and links of the node structure to corresponding terms in the regular expression 506.

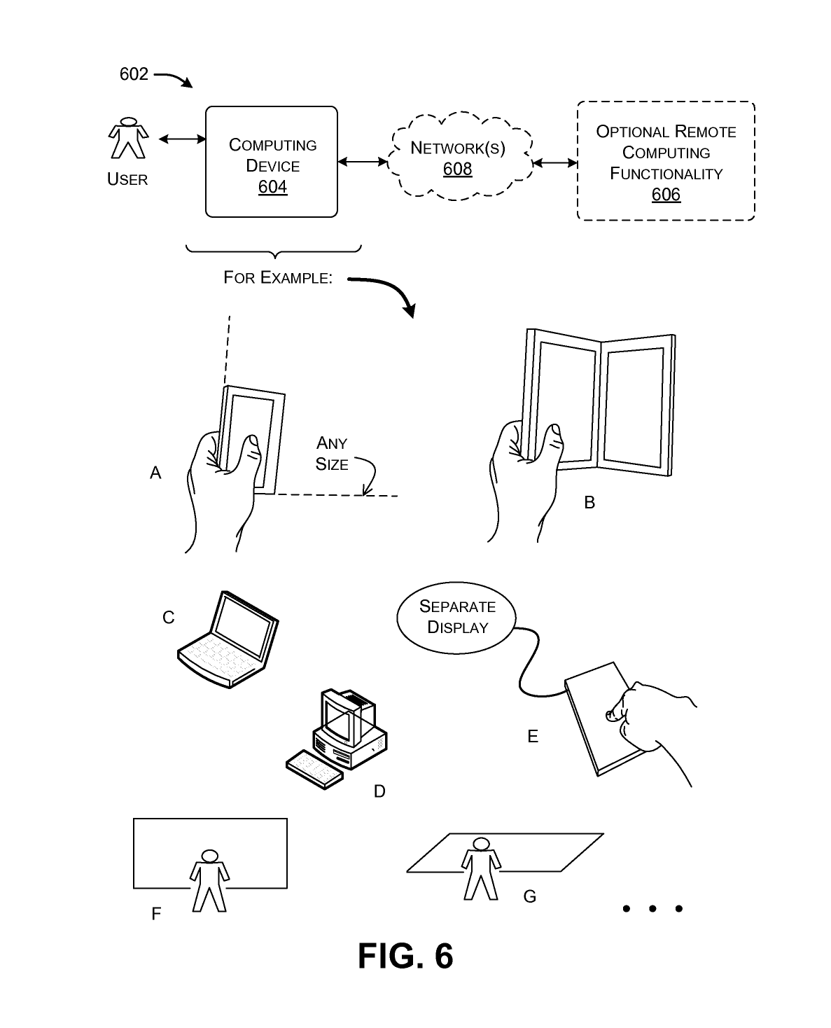

FIG. 6 shows different computing equipment 602 that can be used to implement the SEM 108 of FIG. 5. In one case, the equipment 602 uses at least one computing device 604 to implement the functions of the SEM 108. That is, the computing device 604 may carry out the functions by using one or more processing devices (e.g., central processing units) to carry out program instructions that are stored in the memory of the computing device 604.

In other cases, the equipment 602 may, in addition, or alternatively, carry out one or more functions of the SEM 108 using remote computing functionality 606. For example, the equipment 602 may rely on the remote computing functionality 606 to perform particularly computation-intensive operations of the SEM 108. For instance, the equipment 602 can speed up the search performed by the pattern search module 508 using parallel computing resources provided by the remote computing functionality 606. The remote computing functionality 606 can be implemented using one or more server computing devices and/or other computing equipment. One or more computer networks 608 may communicatively couple the computing device 604 to the remote computing functionality 606.

The computing device 604 itself may embody any form factor(s). For example, in scenario A, the computing device 604 may correspond to a handheld computing device of any size, such as a smartphone of any size, a tablet-type computing device of any size, a portable game-playing device, and so on. In scenario B, the computing device 604 may correspond to an electronic book reader device. In scenario C, the computing device 604 may correspond to a laptop computing device. In scenario D, the computing device 604 may correspond to a (typically) stationary computing device of any type, such as a computer workstation, a set-top box, a game console, and so on. In scenario E, the computing device 604 (of any type) may use a separate digitizing pad (or the like) to provide input information. In scenario F, the computing device 604 (of any type) may use a wall-mounted display mechanism to provide the user interface presentation 502. In scenario G, the computing device 604 (of any type) may use a table-top display mechanism to provide the user interface presentation 502, and so on. Still other manifestations of the computing device 604 are possible.

A.2. Functionality for Creating and Interacting with Visualizations

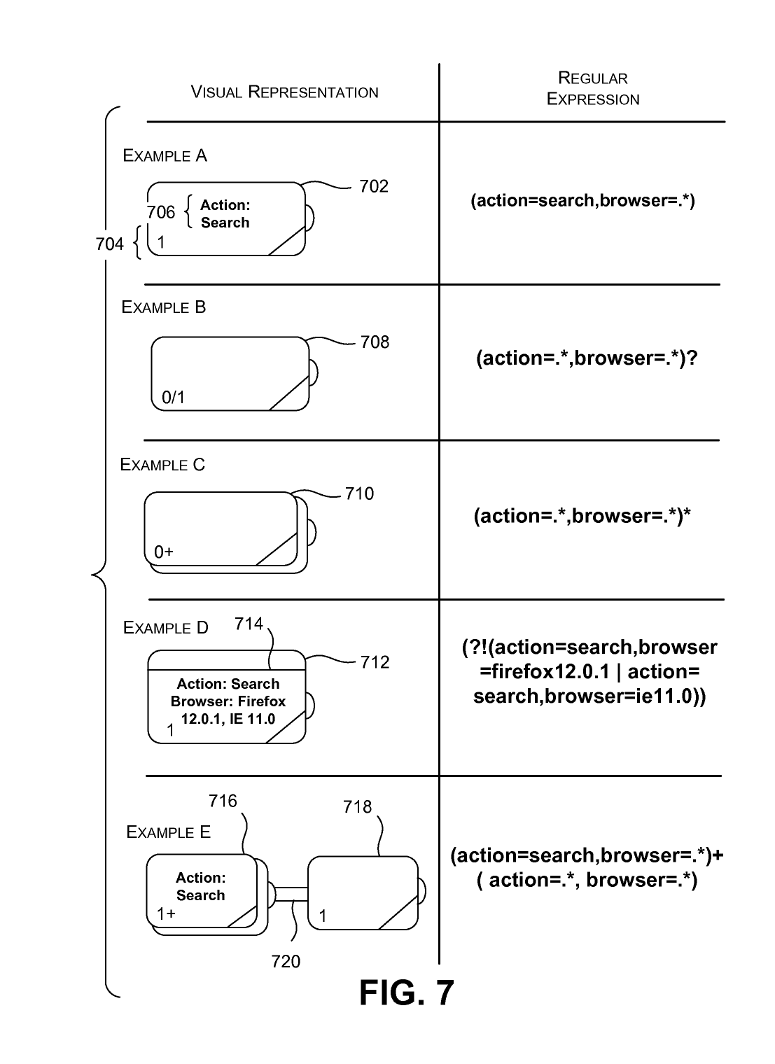

As set forth above, the SEM 108 may create a node structure in response to an investigating user's interaction with the user interface presentation 502. The node structure is composed of one or more nodes, together with zero, one or more links which connect the nodes together. The node structure defines a regular expression, or an expression in some other pattern-matching language. The leftmost column of FIG. 7 shows different node structures that the SEM 108 may create. The rightmost column of FIG. 7 maps the node structures to their corresponding regular expressions.

In general, each node represents an event. Further, each node that the SEM 108 creates is either unconstrained or constrained. An unconstrained node corresponds to any event having any properties. A constrained node describes an event having one or more specified properties. The properties may be expressed, in turn, using one or more attribute-value pairs. For example, a constrained node may describe an event in which a particular action is performed. For example, a constrained node may specify that the action is a search (e.g., “action=search”). A further illustrative constraint may specify that the search is performed by submitting a particular query (e.g., “query=helmet”). A further illustrative constraint may specify that the search is performed using a particular browser (e.g., “browser=Firefox”), and so on. A node can also be constrained with respect to multiple attributes. In addition, or alternatively, a node can be constrained with respect to multiple values per attribute, etc.

Each node may further be associated with an explicitly-specified or implicitly-specified quantifier value. The quantifier value specifies how many events in the original sequence information that the node is permitted to match. For example, a quantifier value of “1” specifies that the node matches exactly one event. A quantifier value of “0/1” specifies that the node matches none or one event. A quantifier value of “0+” specifies that the node matches zero or more events. A quantifier value of “1+” specifies that the node matches one or more events, and so on. The user interface presentation 502 may express the quantifier value using any type of quantifier information, such as alphanumeric text. In summary, then, a node may represent an event (associated with a particular token in the vocabulary, if the node is constrained) and a quantifier value.

The SEM 108 may also display output information for each of the examples of FIG. 7, in an automated and/or in an on-demand manner. For a particular node structure, the output information represents the portions of the event sequences which match the node structure's corresponding regular expression. Such results-reporting functionality is introduced below with respect to FIG. 8, and is illustrated and described in yet greater detail with respect to later figures.

In example A, the SEM 108 creates a single node 702 in response to the investigating user's interaction with the user interface presentation 502. The investigating user has further provided input information that specifies that the node 702 should be constrained to match only one event, where that event corresponds to the action of search. That is, in the visualization of the node 702, quantifier information 704 indicates the number of events that the node 702 is permitted to match (here, “1”). Property information 706 identifies the constraint(s) associated with the node, if any (here, the constraint being “action=search”). This node structure corresponds to a regular expression component “(action=search, browser=.*)”, which indicates that matching is to be performed to find events in which a user performed any type of search using any type of browser, where “*” is a wildcard character. (In all cases described herein, the expressions are set forth using one illustrative syntax; yet other implementations can vary the syntax in one or more ways.)

In example B, the SEM 108 creates another single node 708 in response to the investigating user's interaction with the user interface presentation 502. The node 708 is unconstrained (because it specifies no constraining properties). Further, the node 708 includes quantifier information which indicates that it is permitted to match zero or one events. The node 708 corresponds to a regular expression component “(action=.*, browser=.*)?”. That is, the expression part “(action=.*, browser=.*)” matches any event. The symbol “?” provides an instruction to the pattern search module 508 that the preceding specified action is to be matched zero or one times.

In example C, the SEM 108 creates another unconstrained single node 710 in response to the investigating user's interaction with the user interface presentation 502. But here, the quantifier information indicates that the node is permitted to match zero or more events of any type. Overall, this node structure corresponds to a regular expression component “(action=.*, browser=.*)*”. The expression part “(action=.*, browser=.*)” again matches any event. The last symbol “*” provides an instruction to the pattern search module 508 that the preceding action is to be matched zero or more times.

In example D, the SEM 108 creates a constrained single node 712 in response to the user's interaction with the user interface presentation 502. The constraint specifies an action of search using either one of two specified browsers (Firefox or IE). Further, the input information provided by the investigating user specifies that the constraint defines a negative matching condition, rather than a positive matching condition. As a result of the negative matching constraint, the SEM 108 sets up the node 712 to match any single event, so long as that event does not correspond to a search action that is performed using either of the two specified browsers. A line symbol 714 visually represents the negative status of the property information associated with the node 712, but any icon or information could be used to convey the negative status of the node's constraint. Overall, this node structure corresponds to the regular expression “(?!(action=search, browser=firefox12.0.1|action=search, browser=ie11.0))”. The symbols “?!” express the negative nature of the matching condition.

In example E, in response to the user's interaction with the user interface presentation 502, the SEM 108 successively creates two nodes (716, 718), and then connects the two nodes (716, 718) together in a series relationship. The series relationship specifies an order in which the components, associated with the nodes (716, 718) are to be conjunctively concatenated in the regular expression. The SEM 108 determines whether a portion of an event sequence matches this concatenation of components by determining if it includes instances of the same events arranged in the same order specified by the expression. The user interface presentation 502 may visually represent the connection between the nodes (716, 718) using a link 720. The user interface presentation 502 may set the width (e.g., thickness) of the link 720 to indicate the relative number of events which match the node structure defined by the combination of the two nodes (716, 718).

More specifically, the first node 716 is constrained to correspond to one or more events associated with the property “action=search”. The second node 718 is unconstrained, and is set to match a single event of any type. Together, the node structure specifies any sequence of events in which one or more searches are performed, followed by an action of any type. This node structure corresponds to a regular expression component “(action=search, browser=.*)+(action=.*, browser=.*)”. The symbol “+” indicates that, in order to constitute a match, an event portion under consideration is expected to match the preceding event (corresponding to an event that is constrained by “(action=search, browser=.*)” one or more times. The concatenated remaining part of the expression “(action=.*, browser=.*)” indicates that the event portion is next expected to match an event of any type.

Advancing to FIG. 8, in example F, the SEM 108 creates another multi-node structure in response to the investigating user's interaction with the user interface presentation 502, this time composed of three nodes (802, 804, 806) and two links (808, 810). The first node 802 is constrained to match events having the property “action=search”. The second node 804 is constrained to match events having the property “action=view promotion”, in which the investigating user views some type of promotional material regarding a product. The third node 806 is constrained to match events having the property “action=view product”, in which a user views a product page or the like.

The first link 808 connects the first node 802 to the third node 806, to establish a first node branch. The second link 810 connects the second node 804 to the third node 806, to establish a second node branch. The first node branch collectively describes a matching condition in which an end user performs a search followed by viewing a product. The second node branch collectively describes a matching condition in which the end user views a promotion followed by viewing a product. The links (808, 810) have respective thicknesses which describe the relative number of events associated with the node branches. As shown, more people perform the two events associated with the first node branch, compared to the two events associated with the second node branch.

Overall, the node structure of FIG. 8 combines the node branches in a disjunctive relationship. This relationship means that a portion of an event sequence under consideration will match the node structure if the portion matches either the condition specified by the first node branch or the condition specified in the second node branch. The node structure has the generic regular expression form “((a|b)c)”, and more specifically corresponds to “((action=search)|(action=view promotion)) (action=view product”). (The browser-related information in the expression has been omitted to simplify explanation.)

The user interface presentation 502 further indicates, via a visual group designation 812, that the three nodes (802, 804, 806) form a group of nodes (referred to below as the existing “three-node group”). The pattern search module 508 performs a search for the node structure as a whole, defined by the three-node group. To provide that overall result, the pattern search module 508 also performs a search for each component of the regular expression. In one implementation, the SEM 108 can produce the above-described piecemeal search results using capturing groups, which is a technique used in regular expressions. For example, each node in a node structure constitutes a capture group that captures the events in the matching sequence information that it was responsible for matching.

In one case, the pattern search module 508 performs the above-described searches in a fully dynamic manner, triggered by each change made by the investigating user in constructing or revising the node structure. In addition, or alternatively, the investigating user may expressly invoke the operation of the pattern search module 508 in an on-demand manner.

The user interface presentation 502 can also provide various visualizations of its output information, both for the node structure as a whole, and for individual parts (e.g., individual nodes) of the node structure. For example, the presentation generation module 510 can automatically annotate the three-node group as a whole with results summary information 814. The presentation generation module 510 can also automatically annotate each node branch with results summary information, such as by providing results summary information 816 for the first node branch and results summary information 818 for the second node branch.

In one case, each instance of the results summary information may describe the percentage of sessions that match a particular expression or part of the expression, as well as the percent of end users that match a particular expression or part of the expression. The user interface presentation 502 may depicts these percentages with any visualizations, e.g., by providing numeric information, pie chart information, bar chart information, etc. Note that, in the particular case of FIG. 8, the percentage of sessions for the entire three-node group is the sum of the session percentages of its individual branches, while the percentage of end users for the entire group is the sum of the user percentages of its individual branches.

As will be set forth more fully below, the SEM 108 may produce additional visualizations of the output information in any on-demand manner, with respect to the node structure as a whole or individual nodes within the node structure. For example, in response to an instruction from the investigating user, the SEM 108 may activate a results feature associated with a results icon 820 to access additional output information regarding the three-node group as a whole (and the corresponding regular expression as a whole). The SEM 108 may also activate similar results features associated with individual nodes in response to instructions from the investigating user, to thereby access output information which is relevant to the individual respective nodes (and the corresponding components of the regular expression).

As a final topic with respect to FIG. 8, note that the SEM 108 can treat the existing three-node group associated with the group designation 812 (or any other group of nodes, not shown) as a single entity (or unit) for the purpose of combining the existing three-node group with other nodes, and for performing other operations that pertain to the existing three-node group. In other words, the SEM 108 can treat the existing three-node group as effectively a single node for the purpose of combining the existing three-node group with other nodes (or other groups of nodes). For example, although not shown, the user may instruct the SEM 108 to append another node (or another group of nodes) to the existing three-node group, e.g., by tacking the new node(s) in series to the “beginning” or “end” of the existing three-node group. Or the user may instruct the SEM 108 to add another node (or another group of nodes) in a parallel relationship with respect to the existing three-node group, and so on. The SEM 108 can provide output information for the node structure as a whole, any group of nodes in the node structure, and any individual node in the node structure. A group designation (such as the group designation 812) will alert the user to the fact that a set of nodes are grouped together, and can thus be interrogated and manipulated as a unit.

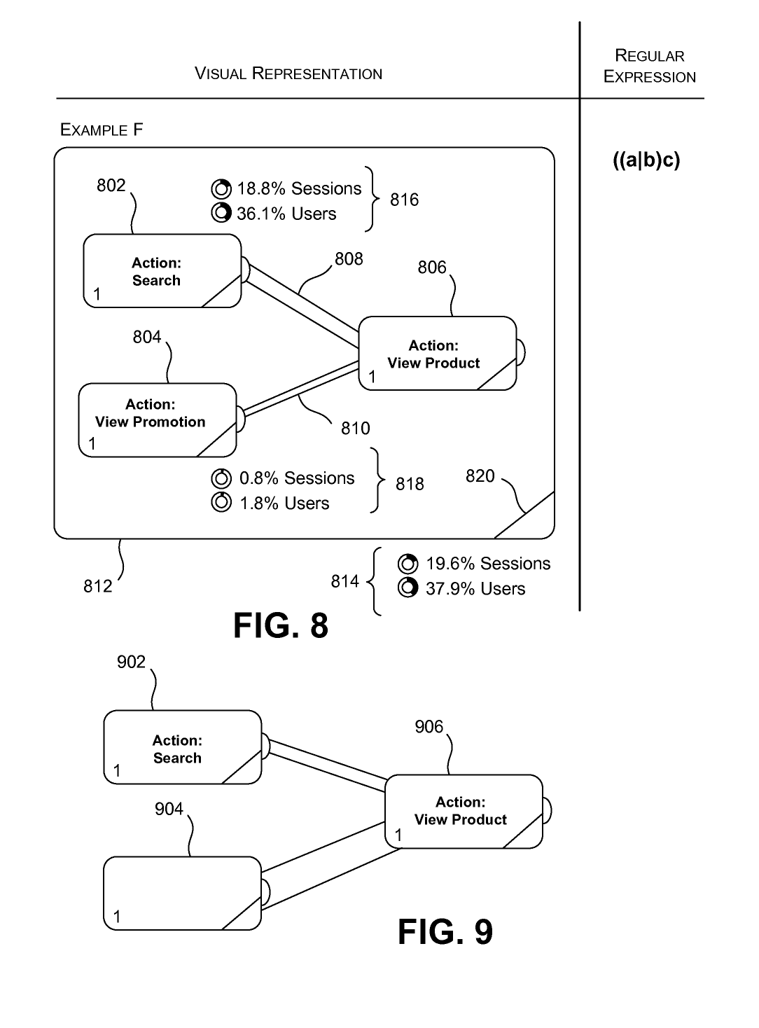

FIG. 9 shows a variation of the visualization of FIG. 8. Here, the node structure again has three nodes (902, 904, 906), with the first node 902 and the third node 906 (associated with a first node branch) defining the same matching condition as the example of FIG. 8. In the case of FIG. 9, however, the second node 904 is now unconstrained, so that it matches any events having any properties.

The vertical position of the first node branch relative to the second node branch defines the order in which the pattern search module 508 matches the two node branches against the original sequence information. That is, the pattern search module 508 will match the first node branch, followed by the second node branch because the first node branch is located above the second node branch. In one implementation, the pattern search module 508 will not report any matches for the second node branch that are already accounted for in the first node branch. That is, the pattern search module 508 will not report any results for the case in which the second node 904 is constrained by “action=search,” as those results have already been collected and reported with respect to the first node branch.

To further illustrate the above characteristic, consider the alternative case in which the positions of the first and second node branches are reversed, such as the first node 902 is unconstrained, and the second node 904 is constrained by the property “action=search”. The first node branch will now report all matches, including matches for the particular case in which the unconstrained node is assigned the property “action=search.” Hence, in that example, the pattern search module 508 would assign no results to the second branch.

In the above example, the ordering of nodes and node branches in the vertical direction determines the precedence or priority in which the above-described greedy collection of results is performed. But the same operation can be performed with respect to any other ordering of nodes along any specified direction. More generally and formally stated, the above manner of operation can be described as follows. Assume that the node branches have respective positions with respect to a particular direction in a space defined by the user interface presentation 502 (here, the particular direction is a vertical direction). As a first principle, the position of each node branch along the particular direction defines the priority of the node branch relative to the other node branches. As a second principle, an event portion that matches plural of the node branches is exclusively reported as matching the node branch that has a highest priority among the collection of node branches.

Examples A-F leveraged certain pattern-matching techniques used in regular expressions, but as applied, in the present context, to event-related tokens, rather than (and/or in addition to) text-based characters. Other examples can use additional regular expressions tools and techniques, although not set forth above. For example, other examples can create expressions using ranges, backreference, nested groups, etc.

The remaining figures in this subsection describe illustrative techniques for generating nodes, interacting with the nodes, invoking visualizations of output information, and so on. In general, all aspects of the user interface presentations that appear in the drawings are set forth in the spirit of illustration, not limitation. Other user interface presentations may vary with respect to the appearance of features in the presentations, the spatial arrangement of those features, the behavior of those features, and so on.

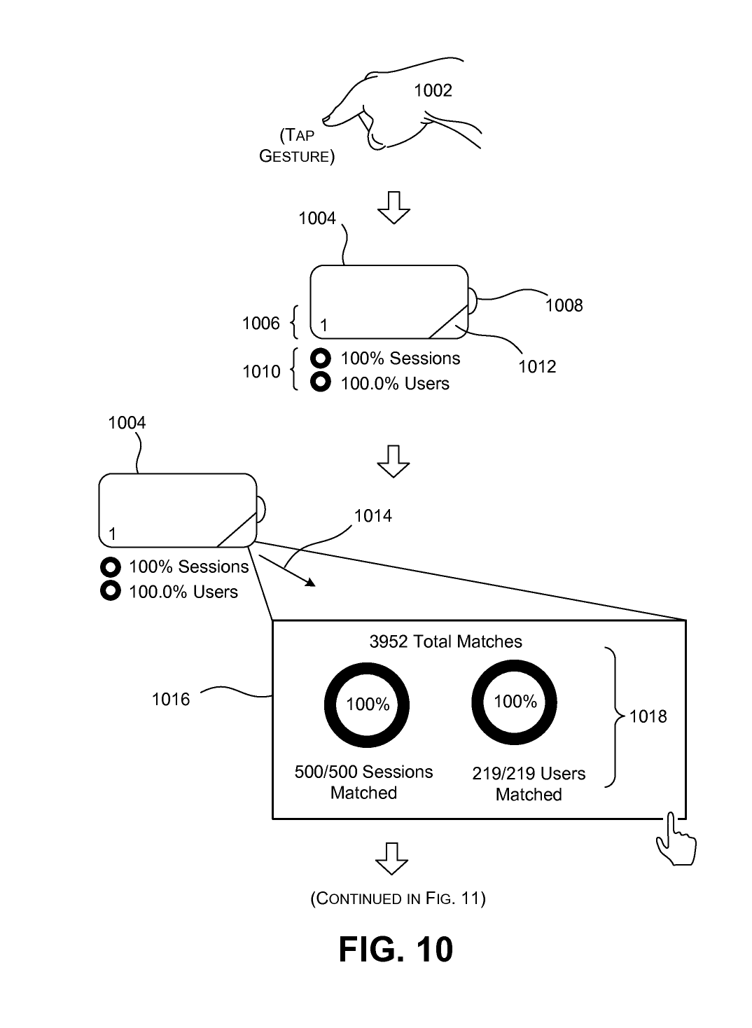

Starting with FIG. 10, in one technique, the input interpretation module 504 detects an investigating user's node-creation touch gesture, e.g., in response to the user's use of a finger of his or her hand 1002 to tap on a surface of the touch input mechanism 116. The SEM 108 responds by displaying a first new node 1004 on the user interface presentation 502. As a default, the node 1004 may be unconstrained, and may have quantifier information 1006 that indicates that it is currently set to match one event. The node 1004 may also include a link symbol 1008, which represents a terminal for later attaching a link to the node 1004. That is, the investigating user may later provide input information that instructs the SEM 108 to connect the node 1004 to another node by drawing a line from the link symbol 1008 to the other node. The presentation generation module 510 may also automatically annotate the node 1004 with results summary information 1010. As this stage the results summary information 1010 indicates that the node 1004 matches 100% percent of the sessions and 100% of the end users, e.g., because it is currently a standalone unconstrained node.

The SEM 108 may provide additional information regarding the output information associated with the node 1004 in response to the investigating user's activation of a results control feature associated with a results icon 1012. For instance, the investigating user may engage the results control feature by executing a dragging gesture (or other gesture), starting from the results icon 1012 and moving away from the node 1004, e.g., in the direction of the arrow 1014. In response to this action, the presentation generation module 510 provides two levels of output information, depending on the distance over which the user performs the drag gesture.

For instance, if the input interpretation module 504 detects that the investigating user has executed a drag movement to within a first range of distances from the node 1004, the presentation generation module 510 will provide a first result visualization 1016. That first result visualization 1016 provides output information 1018 having a first, relatively high, level of detail. For instance, the output information 1018 may indicate the number of sessions that have matched the node's expression, and the number of end users that have matched the node's expression. Note that a session matches the node 1004 if it contains one or more events which match the pattern defined by the node 1004. An end user matches the node 1004 if the user is associated with an event sequence that, in turn, contains a pattern that matches the node 1004.

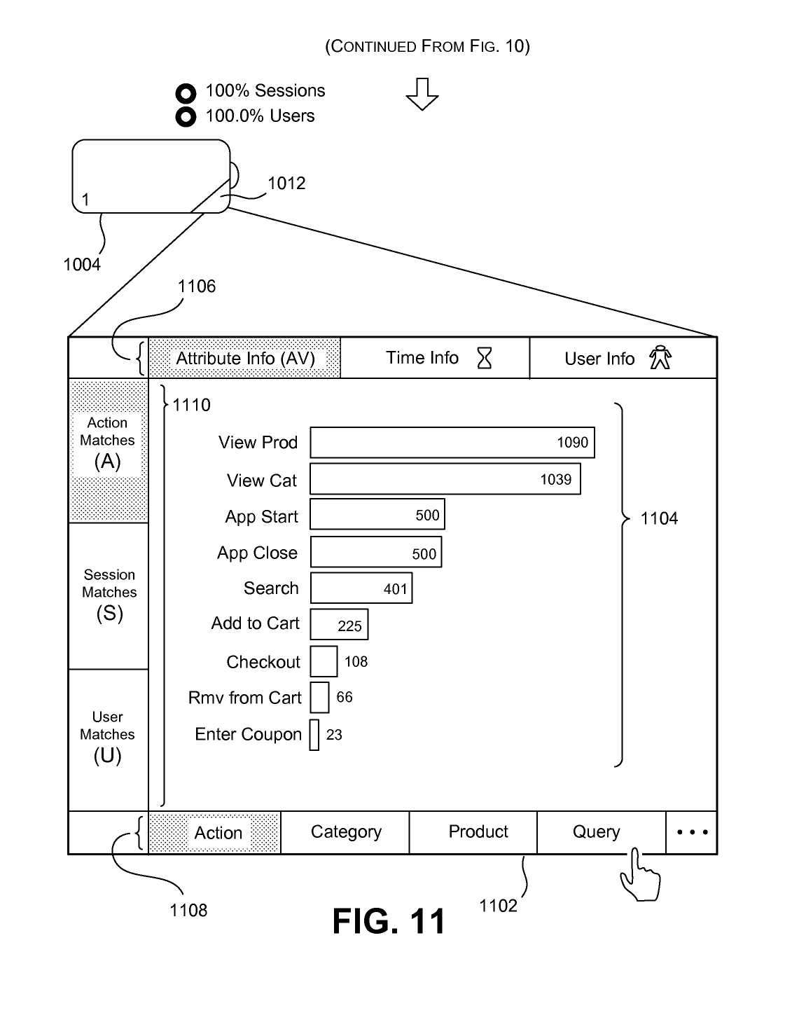

Advancing to FIG. 11, assume that the input interpretation module 504 detects that the investigating user has continued the drag gesture farther away from the node 1004, e.g., to a position within a second range of distances from the node 1004. In response, the presentation generation module 510 provides a second result visualization 1102. The second result visualization 1102 provides output information 1104 having a second level of detail that is greater than the first level of detail provided in the first result visualization 1014 of FIG. 10.

In the particular example of FIG. 11, the output information 1104 includes a histogram associated with the “action” attribute. That is, the histogram describes a number of times that the node 1004 matches portions of the event sequences, for different respective values of the action attribute. For example, the histogram indicates that there are 1090 occurrences in which an event in the original sequence information matches the action-value pair, “action=view product.” There are 1039 instances in which an event matches the action-value pair “action=view category”, and so on.

More generally, the second result visualization 1102 may provide a portal that allows an investigating user to explore different dimensions of the output information. For instance, a first axis 1106 of the result visualization 1102 allows the investigating user to explore different main types of visualizations, associated with different kinds of information extracted from the original sequence information. For example, the investigating user may select a first “attribute info” tab along this axis 1106 to explore histograms (and/or other charts and visualizations) associated with different specific attribute-value pairs. The investigating user may select a second “time info” tab along the axis 1106 to explore visualizations that generally focus on time information associated with the matching sequence information. The investigating user may select a third “user info” tab along the axis 1106 to explore visualizations that generally focus on user-related information associated with the matching sequence information. In the present case, the input interpretation module 504 has detected that the investigating user has selected the first “attribute info” tab.

A second axis 1108 of the result visualization 1102 allows the investigating user to select an option that further refines the basic type of visualization that has been selected via the first axis 1106. For example, in the context of FIG. 11, the second axis 1108 specifies different attribute-related options; an investigating user may select a particular attribute option to instruct the SEM 108 to further refine the basic “attribute info” type of visualization selected via the first axis 1106. More specifically, the illustrative attribute options shown in FIG. 11 include “action,” “category,” “product,” and “query,” etc. An investigating user may select one of these attributes to instruct the SEM 108 to produce a histogram (or other visualization) that conveys the matching sequence information across different values of the selected attribute. In the example of FIG. 11, for instance, the input interpretation module 504 has detected that the investigating user has chosen the “action” option; in response, the presentation generation module 510 shows a histogram of portions that match the specified expression, with respect to different action values associated with those matching portions (e.g., “view product,” view category,” etc.). If the investigating user had selected the “product” option, the presentation generation module 510 would generate output information that shows a histogram of portions that match the expression, with respect to different product values associated with those matching portions.

A third axis 1110 of the result visualization 1102 allows the investigating user to select the hierarchical level in which output information is represented. The investigating user may select a first “action matches” tab on this axis 1110 to explore output information having a “granularity” associated with individual matching portions in the event sequences. For example, assume that a single event sequence includes two or more portions that match an expression under consideration. If the investigating user selects the first tab in the third axis 1110, the presentation generation module 510 will identify these matches as separate discrete “hits.” The investigating user may select a second “session matches” tab on the third axis 1100 to explore output information on a session-based level of granularity. For this level, the presentation generation module 510 generates a single hit for each event sequence that matches an expression under consideration, even though the event sequence may contain plural portions that match the expression. The investigating user may select a third “user matches” tab on the third axis 1110 to explore output information on a user-based level of granularity. This level functions the same as the session-based level, but here the selection principle is the affiliation of each matching portion with an associated end user, not the affiliation with an event sequence. That is, the presentation generation module 510 generates a single hit for each end user insofar as the end user is associated with at least one event sequence having at least one portion that matches the expression under consideration.

An investigating user may explore different levels of visualizations to gain different insights about the matching sequence information. For example, the investigating user may instruct the SEM 108 to first generate a histogram using the “action matches” level of granularity. Assume that that histogram shows a relatively large number of searches performed with respect to a particular product. But when the investigating user examines the same data using the “user matches” level of granularity, the investigating user may discover that the particular search is very popular only with a relatively small group of people, not the overall population. Hence, searching a data set across multiple granularities enhances the investigating user's understanding of the underlying matched sequence information.

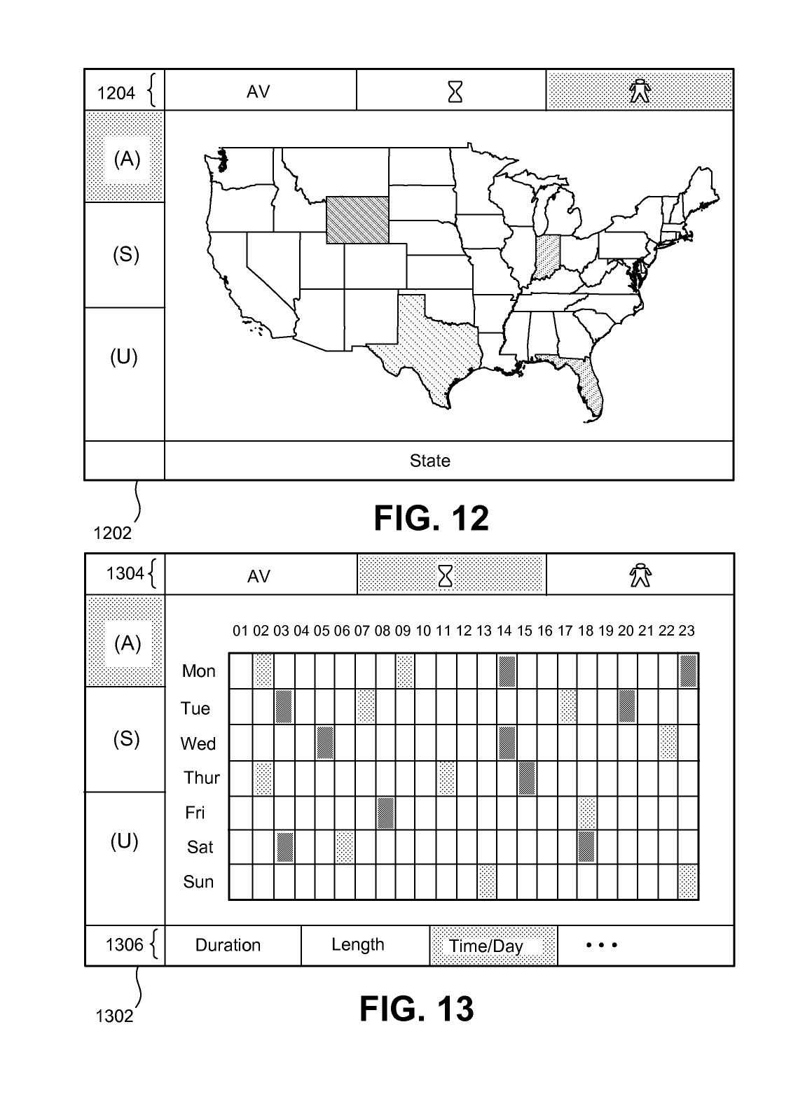

FIG. 12 shows a result visualization 1202 that the SEM 108 presents in response to the investigating user's selection of the third “user info” tab in the first axis 1204, for a particular regular expression. That visualization corresponds to a map of the United States. The map displays each state with a respective level of shading. That level of shading is computed by the SEM 108 by: (1) determining portions of the original sequence information that match the regular expression; (2) determining the identities of the end users who are associated with the matching portions and the geographic locations of those end users; and (3) tallying, for each, state, the number of unique end users who are associated with the matching portions and who are associated with that state, and assigning a shading level based on that number of end users. The identity of each end user can be determined based on user information (and/or connection information) that is provided when the user logs into the application, etc.

FIG. 13 shows a result visualization 1302 that the SEM 108 provides in response to the investigating user's selection of the third “time info” tab in the first axis 1304, for a particular regular expression. Here, the investigating user has further refined the basic “time info” visualization by selecting a “Time/Day” tab in the second axis 1306. In response, the presentation generation module 510 provides a result visualization that corresponds to a “heat map” that shows the time of occurrence of event portions that match the expression under consideration. That is, the shading level of each cell in the heat map reflects a number of portions that match a timeslot associated with that cell. The SEM 108 can generate such a visualization based on timestamp information that is associated with the events in the event sequences.

Although not specifically illustrated in the figures, the investigating user can instruct the SEM 108 to produce other types of time-based visualizations by selecting other time-related tabs in the second axis 1306. For example, by selecting a “duration” tab, the investigating user may instruct the SEM 108 to generate output information regarding the durations associated with the event portions that match the expression under consideration. That is, the duration of a portion may be measured by the amount of time that transpired between the first event in the matching portion and the last event in the matching portion. By selecting a “length” tab, the investigating user may instruct the SEM 108 to generate output information regarding the lengths associated with the matching portions. That is, the length of a matching portion reflects the number of events in a portion.

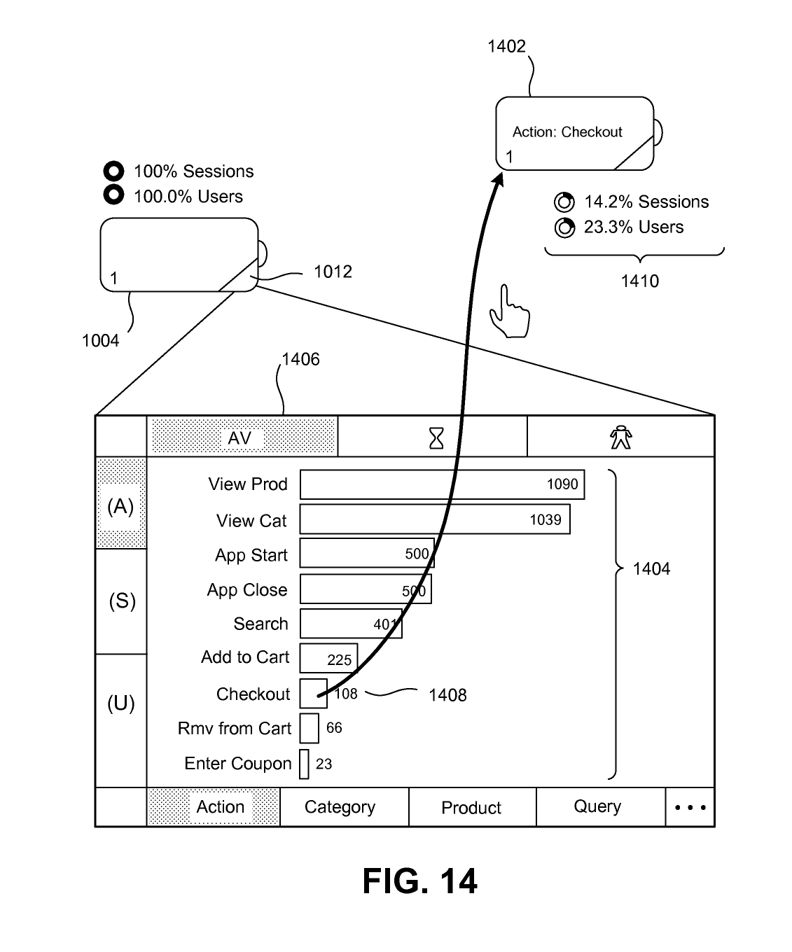

FIG. 14 shows one technique for constraining the existing node 1004, or for creating a new node 1402. In this approach, the input interpretation module 504 detects that the investigating user has executed a drag gesture in the same manner described above, starting from the results icon 1012. In response, the SEM 108 presents output information 1404 in a result visualization 1406. Once again, the SEM 108 may form the output information 1404 as a histogram of matching portions over different action values. Although not shown, the investigating user can instruct the SEM 108 to constrain the current node 1004 (which, at this stage, is still currently unconstrained) by tapping on one of the action values in the histogram. For example, the investigating user can instruct the SEM 108 to constrain the current node 1004 with the attribute-value pair “action=checkout” by tapping on the “checkout” item 1408 in the histogram.

Instead of the above operation, however, assume that the input interpretation module 504 detects that the investigating user has dragged out the “checkout” item 1408 to a particular location in the space of the user interface presentation 502. In response, the presentation generation module 510 creates the new node 1402, which is now constrained based on the property “action=checkout”. The presentation generation module 510 further displays the new node 1402 at the location in the user interface presentation 502 chosen by the investigating user, e.g., corresponding to the position at which the investigating user ends the drag-out gesture. The presentation generation module 510 also generates results summary information 1410 which summarizes the matching results associated with new standalone node 1402.

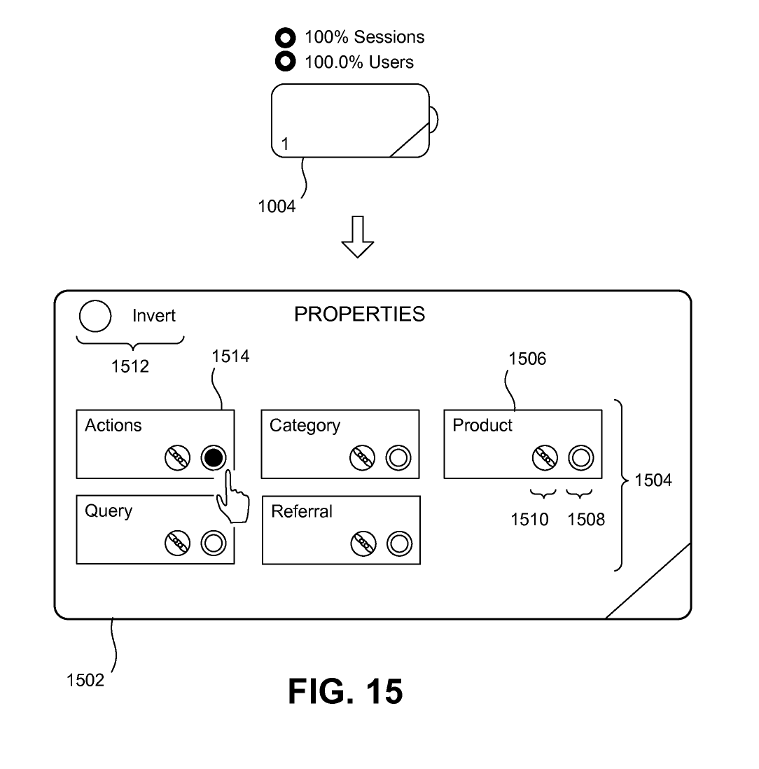

The above-described technique (of FIG. 14) is just one way among many to constrain an existing node or create a new node. In the approach of FIG. 15, for example, the SEM 108 may constrain the existing node 1004 in response to detecting that the user has made a tapping gesture in the middle of the existing node 1004, which causes the presentation generation module 510 to produce the property-setting panel 1502. Or the investigating user may perform a tapping gesture at a new location on the interface presentation 502 to instruct the SEM 108 to create a new node (as per the procedure shown in FIG. 10), and then subsequently tap on the body of the new node to instruct the SEM 108 to produce the property-setting panel 1502.

The property-setting panel 1502 includes a number of control features that allow an investigating user to enter instructions which will constrain the node with which the panel 1502 is associated. For example, the property-setting panel 1502 includes a group of control features 1504 for constraining different attributes of the node 1004, such as the action attribute, category attribute, product attribute, and so on.

More specifically, each control feature in the group of control features 1504 has two embedded control features. For example, the representative control feature 1506 for the product attribute includes a first embedded control feature 1508 and a second embedded control feature 1510. An investigating user may interact with the first control feature 1508 to activate a list of attribute values associated with the attribute under consideration—here, the product attribute. The investigating user may subsequently select one of the values to instruct the SEM 108 to constrain the node 1004 to the thus-selected attribute-value pair. The first control feature 1508 will thereafter be displayed in color or other visual attribute that designates that it is active, meaning that an attribute-value pair associated with that attribute now constrains the node 1004 under consideration.

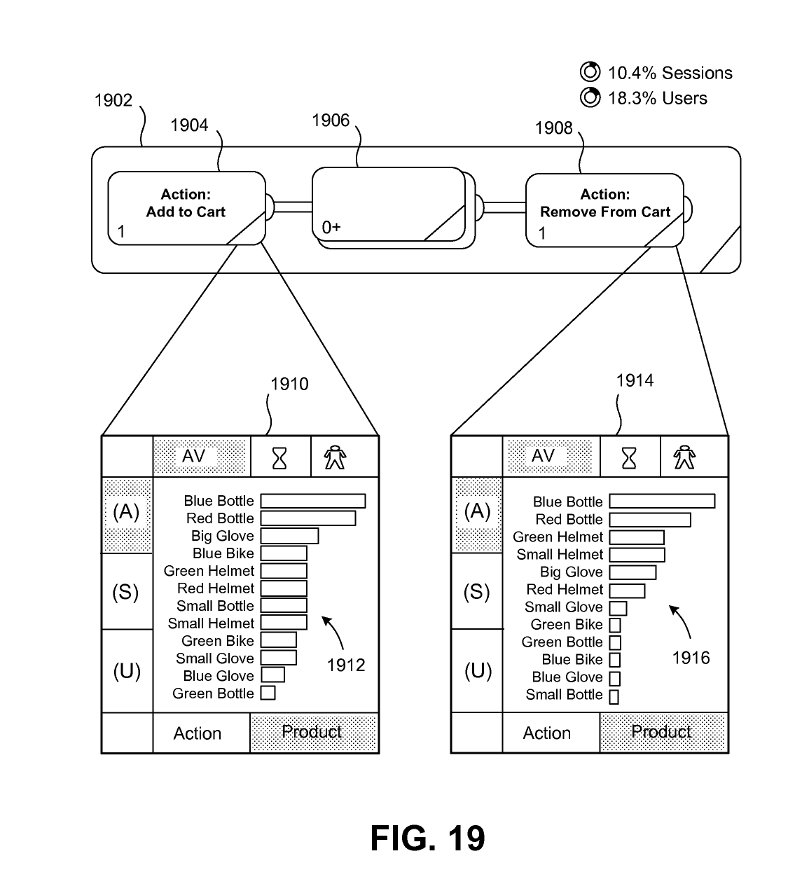

The second embedded control feature 1510 allows an investigating user to instruct the SEM 108 to bind one or more attribute values (here, product values) associated with the current node with other actions performed by another node, with respect to the same attribute values. In executing a search based on the resultant expression, the SEM 108 will find matches where the specified attribute has the same value(s) across the two or more specified nodes. FIGS. 19-21, below, are devoted to illustrating this behavior in greater detail. Suffice it to say here that the SEM 108 may invoke the binding operation in response to detecting that the user has dragged a binding icon from the property-setting panel 1502, associated with the node 1004, to whatever node is to be bound with the node 1004. The user can perform same operation to instruct the SEM 108 to bind other attribute-value pairs between two nodes.

Finally, the property-setting panel 1502 includes an inversion control feature 1512. The SEM 108 may detect when an investigating user invokes the inversion control feature 1512, and, in response, set up the negative of whatever property has been defined using the above-described control features 1504. For example, assume that the investigating user interacts with the “actions” control feature 1514 to instruct the SEM 108 to set the attribute-value pair “action=checkout.” By doing so, the investigating user instructs the SEM 108 to constrain the node 1004 to that attribute-value pair. If the investigating user then subsequently activates the inversion control feature 1512, then the SEM 108 will set up a constraint for the node 1004 that specifies that a matching condition is satisfied when an event is encountered that is not constrained by the “action=checkout” property. The presentation generation module 510 may designate the node 1004 as being governed by a negative property using the line symbol 714 shown in FIG. 7, or some other symbol or icon.

In yet another case, not shown, the presentation generation module 510 may prepopulate the user interface presentation 502 with one or more unconstrained nodes, e.g., without requiring the user to perform the kind of tapping gesture shown in FIG. 10 to create new nodes. The investigating user may then instruct the SEM 108 to refine these nodes in the manner describe above, e.g., by adding constraints to the nodes, connecting the nodes together, etc.

In yet another case, the presentation generation module 510 can also present one or more default node structures, each having one or more component nodes, any of which may be constrained or unconstrained. The investigating user may then instruct the SEM 108 to refine one of these node structures in the manner described above. It may be beneficial to produce such stock starting examples to facilitate an investigating user's interaction with the SEM 108, particularly for the benefit of a novice investigating user who may be unsure how to start using the SEM 108, e.g., because the investigating user has not yet interacted with the SEM 108.

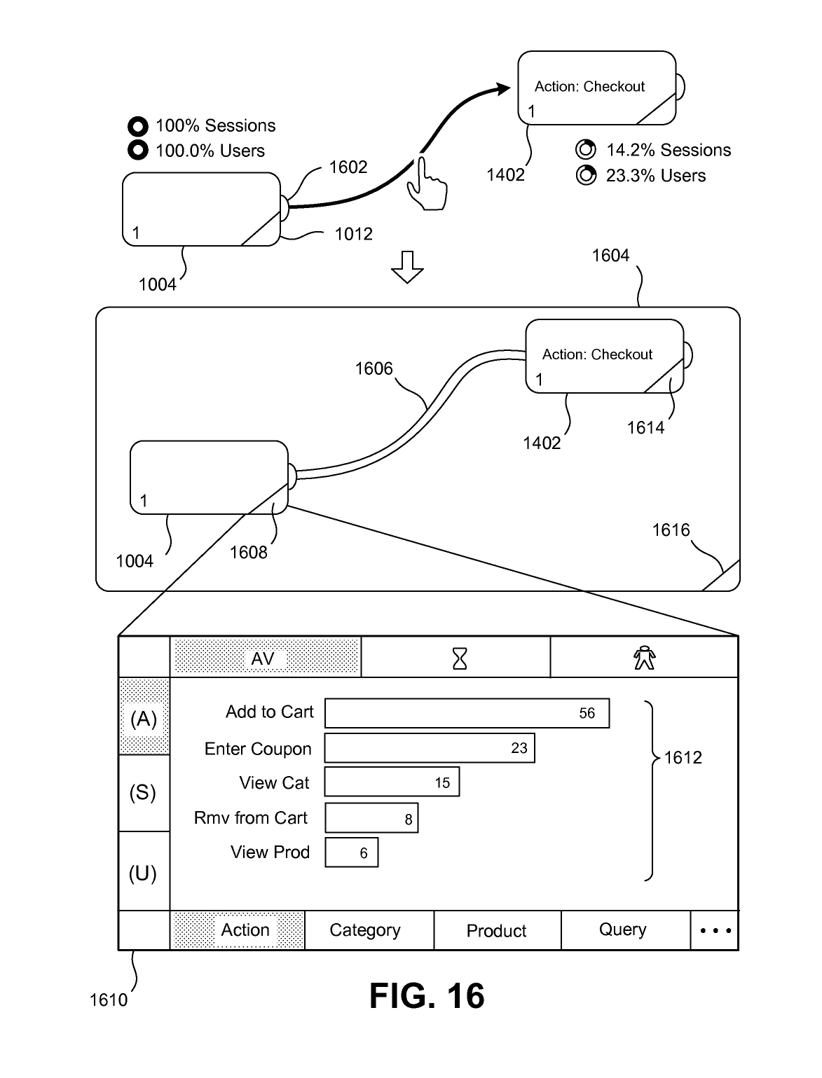

Advancing to FIG. 16, assume that, at this stage, the SEM 108 has now created an unconstrained original node 1004 (as per the technique of FIG. 10) and a constrained second node 1402 (as per the technique of FIG. 14). Further assume that the investigating user now wishes to connect these two nodes (1004, 1402). To do so, the user may touch the link icon 1602 of the first node 1004 and then execute a dragging gesture to the second node 1402. In response to detecting this gesture, the SEM 108 produces the node structure shown in FIG. 16, associated with the group designation 1604. In this node structure, the first node 1004 is now connected to the second node 1402 via a link 1606. The thickness of the link 1606 reflects the number of portions of the original sequence information which match the collective constraints associated with the node structure.

Assume that the input interpretation module 504 now detects that the investigating user has activated a results feature associated with the results icon 1608, associated, in turn, with the first node 1004. In response, the presentation generation module 510 displays a result visualization 1610. The result visualization 1610 now presents output information 1612 in the form of a histogram that shows different actions that have been performed in the original sequence information prior to performing a checkout action. Note that, by virtue of the investigating user's instruction to connect the first node 1004 to the second node 1402, the actions shown in the histogram of FIG. 16 are further restricted, compared to the actions shown in the histogram of FIG. 14 (where, at that stage, the node 1004 was not constrained).

Alternatively, the investigating user may activate a results feature (associated with a results icon 1614) that is associated with the second node 1402, causing the SEM 108 to reveal a result visualization (not shown) associated with this node 1402. Alternatively, the investigating user may activate a results feature (associated with a results icon 1616) associated with the node structure as a whole (e.g., with the group as a whole), causing the SEM 108 to reveal a result visualization (not shown) associated with the group as a whole.

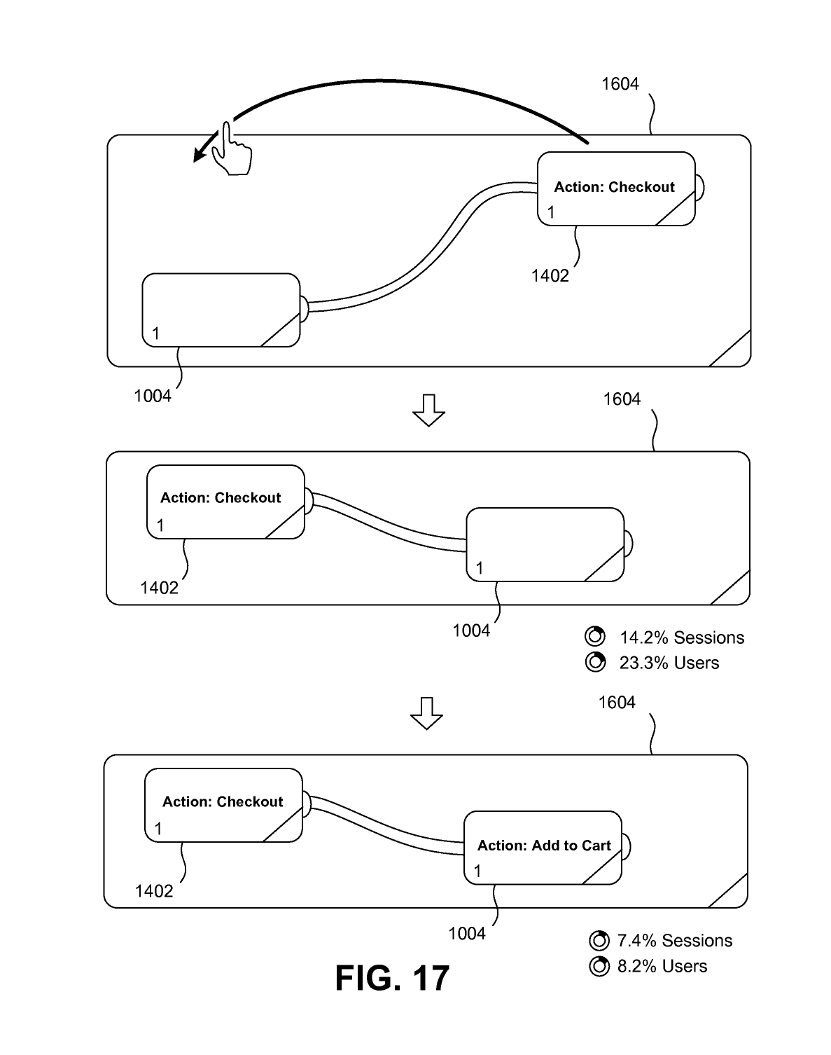

In the example of FIG. 17, now assume that the input interpretation module 504 detects that the investigating user has dragged the second node 1402, currently located at a position to the right of the first node 1004, to a new position that is located on the left side of the first node 1004. This action causes the SEM 108 to generate a different regular expression and different corresponding matching results. For example, the node structure in its original configuration specified a pattern in which an end user performed any action, followed by a checkout action. When the nodes are switched in the manner shown in FIG. 17, the resultant node structure specifies a pattern in which the end user performs a checkout operation followed by any action.

In the last stage of FIG. 17 (shown at the bottom of FIG. 17), assume that the input interpretation module 504 detects that the investigating user has constrained the node 1004 by setting the property “action=add to cart”. The node structure as a whole now specifies a pattern in which an end user performs a checkout action, followed by adding an item to the cart. This is a somewhat unusual combination of actions, since a checkout action would normally mark the end of the user's transaction. If there are any matches for this pattern, the investigating user may investigate the results in any of the ways described above. For instance, in one particular scenario, the investigating user may ultimately instruct the SEM 108 to invoke the type of user-related result visualization shown in FIG. 12 to discover that most of the end users who performed the above-described series of actions were located in particular regions of the country. These end users may perform this particular action, in turn, in response to a particular promotional program that has been administrated in particular states, but not others. This is an example of the powerful types of insight that can be gleaned through interaction with the SEM 108, which would not otherwise be available to the investigating user.

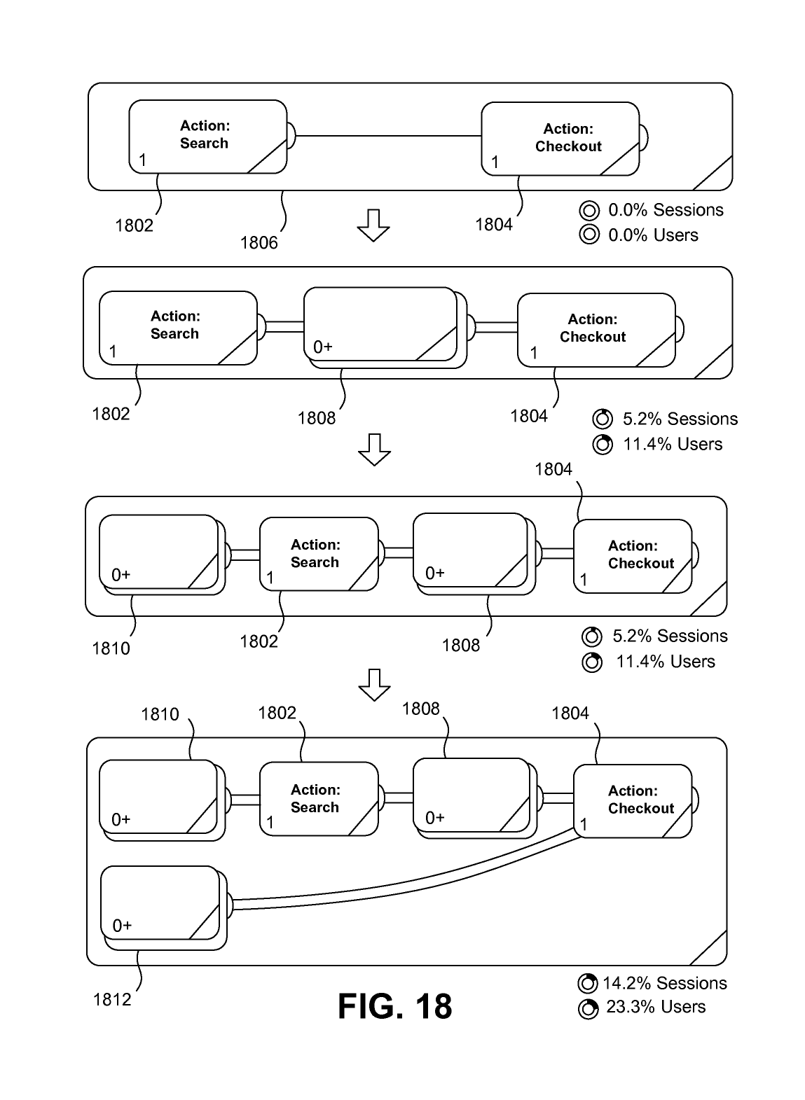

FIG. 18 shows an example in which the SEM 108 creates a node structure having five nodes in response to instructions from the investigating user. Assume that the investigating user begins the operations shown in FIG. 18 by instructing the SEM 108 to create a node structure having two nodes (1802, 1804). The first node 1802 is constrained by the property “action=search”, while the second node 1804 is constrained by the property “action=checkout”. A group designation 1806 represents the node structure as a whole.

The investigating user finds that the node structure, as originally defined, has no matches, since no one has directly advanced to the checkout stage after performing a search (e.g., because this operation may be impossible in the particular application under consideration). In response to this observation, the investigating user may instruct the SEM 108 to add an unconstrained intermediary node 1808, and set the quantifier value of that node 1808 to “0+”, indicating that this node 1808 is permitted to match zero or more events within the original sequence information. The investigating user may then instruct the SEM 108 to add a similarly unconstrained node 1810 to the beginning of the node structure. In response, the presentation generation module 510 generates results summary information that now indicates that the node structure matches 5.2% of the sessions and 11.4% of the end users.

With respect to the quantifier values shown in FIG. 18 (or any other figure for that matter), the presentation generation module 510 may provide various control features that allow an investigating user to change the quantifier value associated with any particular node. For example, when creating a new node, the presentation generation module 510 may set the quantifier value to a default value, where that default value can be automatically chosen to correspond to the value that would most likely be chosen by users in that particular context, as reflected by pre-stored information which specifies default quantifier values for different respective contexts. Thereafter, the investigating user may tap on the visual representation of the existing quantifier value to instruct the SEM 108 to change the value, e.g., by sequencing through a loop of quantifier values with successive taps, etc.

In the last stage of the example shown in FIG. 18, the input interpretation module 504 detects that the investigating user has added yet another node 1812 to the node structure and connected that node 1812 to the final node 1804 in the node structure. This operation prompts the SEM 108 to create two parallel node branches. The top node branch finds all event sequences in which an end user performs a search at some stage, followed by a checkout operation. The bottom node branch finds all event sequences in which the end user performs zero, one, or more actions of any type, followed by a checkout operation.

Based on the “greedy” matching principle set forth above, the bottom node branch does not contain any matches that have already been captured in response to execution of the search for the top node branch. This is because the top node branch has priority in the search operation over the bottom node branch, due to its position with respect to the bottom node branch. However, other implementations may adopt different search behavior than that described above.

FIGS. 19-21 collectively show another example in which the SEM 108 links attributes between two nodes in a node structure in response to an instruction from an investigating user. Starting with FIG. 19, the example begins with the scenario in which the SEM 108 has created a group (designated by group designation 1902) associated with a node structure that has three nodes (1904, 1906, 1908), arranged in series. The first node 1904, having a quantifier value set to one event, is constrained by the property “action=add to cart”. The second node 1906 is unconstrained, and has a quantifier value set to zero or more events. The third node 1908 has a quantifier value set to one event, and is constrained by the property “action=remove from cart”. Collectively, the expression defined by the node structure finds patterns in which the end users add any product to a cart, perform zero or more intermediary actions, and then remove any product from the cart.

In response to the investigating user's instruction, the SEM 108 may generate a result visualization 1910 associated with the first node 1904, to reveal output information 1912. That output information 1912 reflects different products that the end users have added to the cart. In response to the investigating user's instruction, the SEM 108 may similarly activate another result visualization 1914 associated with the third node 1908 to reveal output information 1916. That output information 1916 reflects different products that the end users have subsequently removed from the cart.

However, assume that the investigating user is interested in exploring the specific scenario in which an end user adds a particular product to the cart and then subsequently removes that same product from the cart. The node structure of FIG. 19 does not currently capture or reveal this information. That is, the node structure currently reveals independent add-to-cart actions and remove-from-cart actions, there being no necessary nexus between these operations. The investigating user can instruct the SEM 108 to further restrict the add-to-cart node 1904 by selecting one or more specific products to the cart, such as the “blue bottle” item. This operation will cause the SEM 108 to limit the results associated with the “remove-from-cart” node, e.g., by now showing products that the end users removed from the cart after adding the “blue bottle” to the cart. But this information still fails to reflect the desired nexus that is sought by the investigating user.

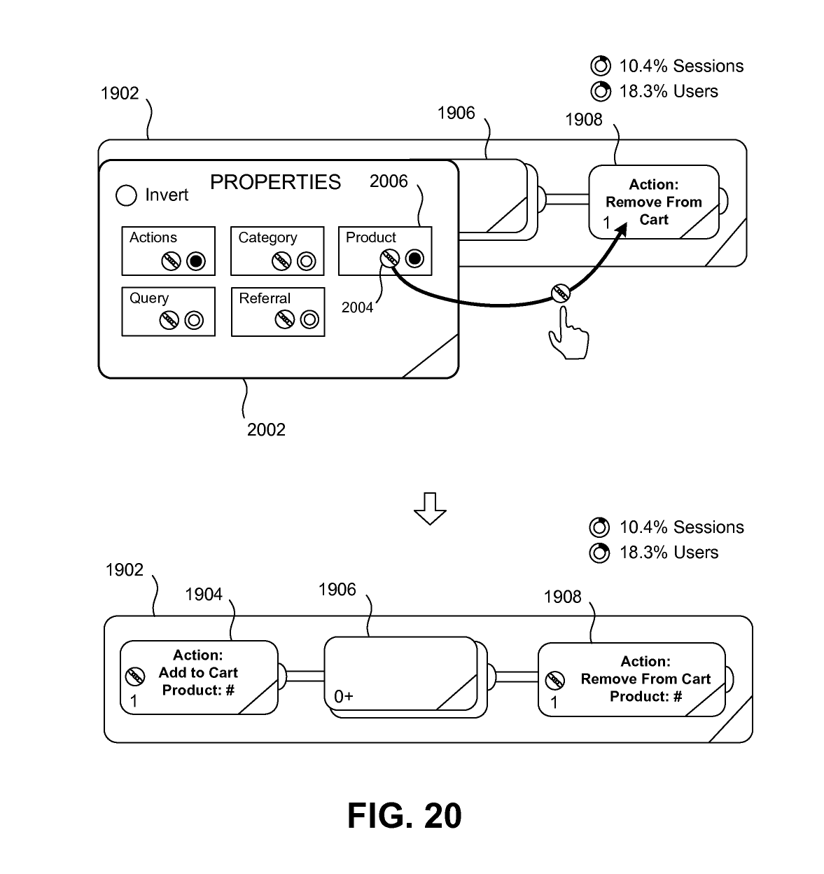

Advancing to FIG. 20, the investigating user may achieve the above-described analysis goal by instruct the SEM 108 to activate a property-setting panel 2002 associated with the first node 1904 (e.g., the node corresponding to the add-to-cart action). The investigating user may then drag a binding icon 2004 from the first node 1904 to the third node 1908. The binding icon 2004 is associated with a binding control feature, which, in turn, is associated with a product control feature 2006 of the property-setting panel 2002. In response to detecting this gesture, the SEM 108 links the add-to-cart actions performed on particular products (in node 1904) with the remove-from-cart actions performed on the same products (in node 1908). To achieve the above result, the SEM 108 can produce an appropriate expression that implements the user's thus-defined query, e.g., by using the backreference technique in a regular expression matching language. That is, such an expression can identify matching event information within an event sequence and then use the backreference technique to find repeated occurrences of that same event information in the event sequence.

The bottom stage of FIG. 20 illustrates the result of the gesture performed by the investigating user. Here, both the first node 1904 and the third node 1908 include a binding icon that is displayed in an active state to indicate that these two nodes are now bound together in the manner described above. The label information associated with these two nodes (1904, 1908) also indicates that these two nodes (1904, 1908) are bound together with respect to actions taken on products.

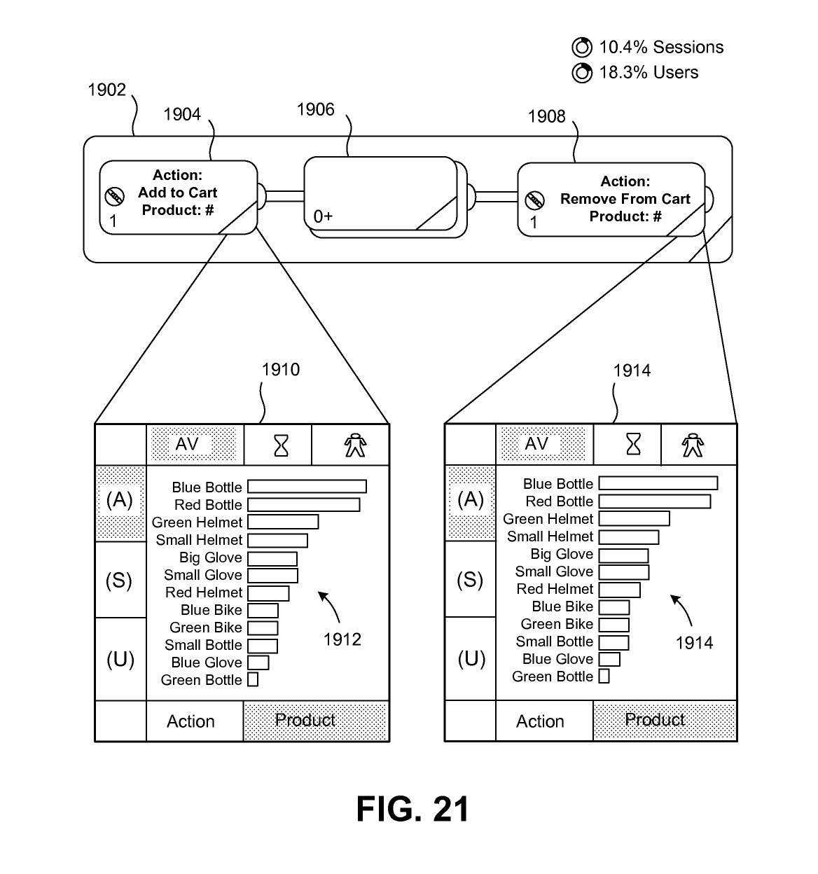

Advancing to FIG. 21, in response to the investigating user's instructions, assume that the SEM 108 now reactivates the first result visualization 1910 associated with the first node 1904 and the second result visualization 1914 associated with the third node 1908. The first and second visualizations (1910, 1914) now contain the same product results, confirming that the actions have been bound together in the manner described above.

As a final topic in this section, the SEM 108 can incorporate a number of additional features not yet described. For example, the SEM 108 can incorporate one or more post-matching filters which filter the matching sequence information produced by the SEM 108 based on one or more filtering factors specified by the investigating user. The filters are qualified using the term “post” because they operate on the output information after the expression-based matching has been performed by the SEM 108. Alternatively, or in addition, the filters can operate on the input event data before the matching has been performed.

For example, assume that the investigating user is interested in finding output information for the specific scenario in which end users added more than five items to a shopping cart, after performing zero or more preceding actions. The investigating user may first instruct the SEM 108 to set up a node structure which captures the case in which the end user adds any number of items to a shopping cart after performing zero or more preceding actions. The SEM 108 may execute the resultant regular expression to generate initial matching sequence information. Then, the SEM 108 can filter the initial matching sequence information to find those cases in which the end user added more than five items to his or her shopping chart, thereby yield refined matching sequence information.

Similarly, assume that the investigating user is interested in a case in which the end user performed a search and then performed a checkout operation, with any number of intermediary actions, but all within a predetermined amount of time. The investigating user may again instruct the SEM 108 to create a node structure which captures all cases in which an end user performed a search followed, at some point, by a checkout operation. This yields initial matching sequence information. The SEM 108 may then filter the initial matching sequence information to find the particular examples which satisfy the investigating user's timing constraints, e.g., based on the timestamp information associated with the events in the initial matching sequence information.

As an alternative way (or an additional way) to address the above search tasks, the event vocabulary can be expanded to incorporate new properties. The new properties may allow, for instance, an investigating user to specify constraints that pertain to quantity, temporal duration, etc.

For example, one new property may indicate that an event is expected to occur within a prescribed temporal window after the occurrence of a preceding event. The pattern search module 508 will register a match for this event only if all of its properties are satisfied, including the timing constraint. More broadly stated, the SEM 108 can be configured to generate output information based on a consideration of time information associated with at least one event relative to time information associated with at least one other event. That manner of operation, in turn, can be based on the use of post-matching filters, the introduction of time-specific tokens into the vocabulary, etc., or any combination thereof.

As another feature, the SEM 108 can perform other types of follow-up analysis. For example, the user may instruct the SEM 108 to create two node groups, each composed of one or more individual nodes arranged in any configuration. The SEM 108 may then produce a chart (or other output visualization) which compares the output information associated with the two groups.

According to another feature, the SEM 108 may use a vocabulary to construct its expressions that is extensible in nature. In other words, new types of events can be added to the vocabulary and/or existing types of events can be removed from the vocabulary.

According to another feature, the SEM 108 can allow a user to enter custom constraints, rather than, in or in addition to, selecting the constraints from a discrete list of fixed constraints. For example, the SEM 108 can allow the user to enter a constraint “query=red bike”, e.g., in response to the user typing “red bike” or writing “red bike” on a touch-sensitive surface of a touch input mechanism (e.g., using a stylus, finger, or other writing implement).

According to another feature, the SEM 108 can allow a user to specify fuzzy constraints in addition to non-fuzzy attribute-related constraints. For example, the SEM 108 can allow the user to input the constraint “query=bik” to retrieve the actual query “red bike” and “blue bike”, etc., if these queries exist in the original sequence information.

According to another feature, the SEM 108 can be designed in an extensible manner to allow for the introduction of new visualization techniques, such as the introduction of new types of charts.

B. Illustrative Processes

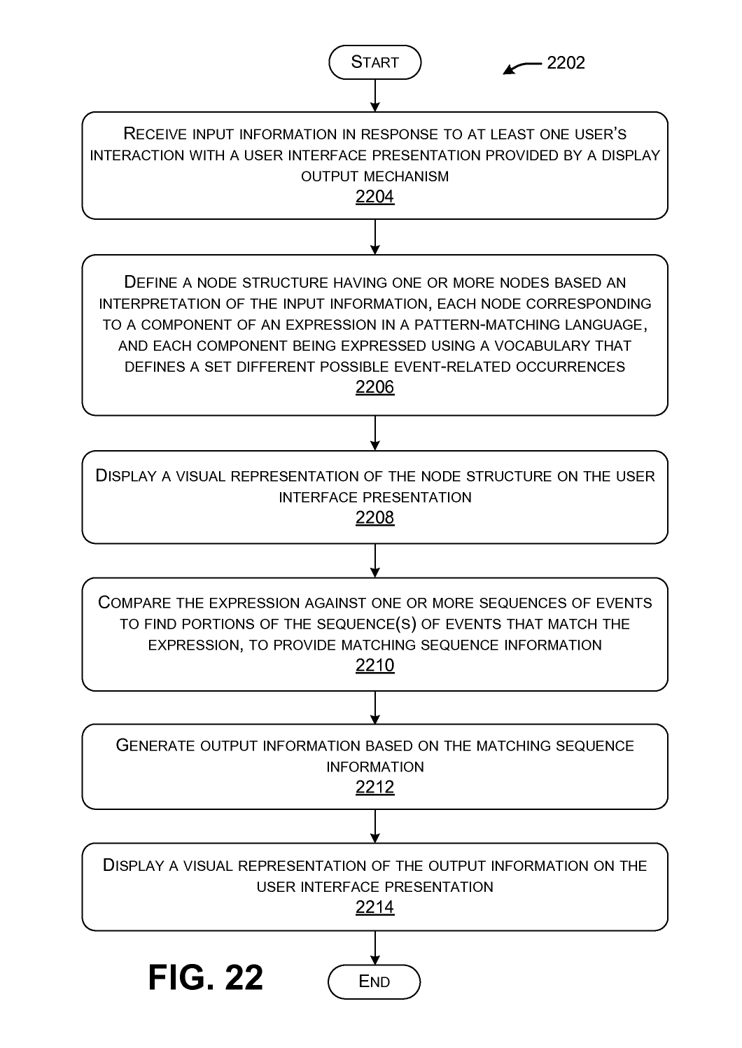

FIG. 22 shows a process 2202 that explains one manner of operation of the sequence exploration module (SEM) 108 of Section A in flowchart form. Since the principles underlying the operation of the SEM have already been described in Section A, certain operations will be addressed in summary fashion in this section.

In block 2204, the SEM 108 receives input information in response to an investigating user's interaction with the user interface presentation 502 provided by the display output mechanism 122. In block 2206, the SEM 108 defines a node structure having one or more nodes, based on an interpretation of the input information. Each node corresponds to a component of an expression in a pattern-matching language, and each component is expressed using a vocabulary that defines a set different possible event-related occurrences. In block 2208, the SEM 108 displays a visual representation of the node structure on the user interface presentation 502. In block 2210, the SEM 108 compares the expression against one or more sequences of events to find portions of sequences that match the expression, to provide matching sequence information. In block 2212, the SEM 108 generates output information based on the matching sequence information. In block 2214, the SEM 108 displays a visual representation of the output information on the user interface presentation 502.

Note that FIG. 22 describes the above operations in a series relationship merely to facilitate explanation; in actuality, the SEM 108 can perform these operations in any order (including a parallel order), and the SEM 108 can repeat any individual operation any number of times in the process of creating and applying a final expression. For example, the SEM 108 can repeat the operations shown in FIG. 22 (or a subset of the operations) each time that the user makes a change that alters the makeup of the node structure. For instance, the SEM 108 can automatically and dynamically repeat the operations when the user instructs the SEM 108 to add or remove an individual node, connect nodes together in a particular manner, change a property of any individual node, and so on. Alternatively, or in addition, the SEM 108 can perform some of the operations shown in FIG. 22 in an on-demand manner, e.g., in response to an explicit instruction from the user.

The SEM 108 can also operate in different dynamic modes that exhibit different behavior. For example, in one case, the SEM 108 can operate on a static corpus of event sequences in the original sequence information, which is persisted in the data store 106 and/or elsewhere. In another case, the SEM 108 can operate on a stream of event sequences received from any source(s), e.g., as the event data is provided by the source(s). This event data may be buffered in the data store 106 (and/or elsewhere), but is not necessarily persisted therein. In this case, the SEM 108 produces output information that changes over time to reflect changes in the input event data that has been received thus far, up to the present time.

As another feature, the SEM 108 can also provide its output information in different dynamic modes. In a first mode, the SEM 108 can update a visualization of the output information (e.g., in a histogram or other visualization) only when the output information has been generated in its entirety. In a second mode, the SEM 108 can update a visualization of the output information in a piecemeal fashion without having generated all of the output information. For example, consider the case in which the SEM 108 is asked to analyze a very large corpus of event input data, e.g., corresponding to several gigabits of information or larger. The SEM 108 can update the output visualization on a continual basis as the corpus of input data is processed or on a periodic basis. The user will observe the output visualization as dynamically changing until all of the input data is processed. The user may prefer to receive results in the above-described dynamic piecemeal fashion to avoid a potentially long delay in which the user would otherwise receive no results. In the context of FIG. 22, the SEM 102 may achieve the above-described dynamic execution by performing the operations shown in FIG. 22 in a pipeline, where some operations take place in parallel with other operations with respect to different portions of event data.

More generally, the flowchart shown in FIG. 22 is intended to encompass at least all of the modes of operation described above.

In conclusion, the following summary provides a non-exhaustive list of illustrative aspects of the technology set forth herein.

According to a first aspect, a technique is described, implemented by one or more computing devices, for exploring sequences. The technique operates by receiving input information in response to at least one user's interaction with a user interface presentation provided by a display output mechanism. The technique then defines a node structure having one or more nodes based an interpretation of the input information. Each node corresponds to a component of an expression in a pattern-matching language, and each component is expressed using a vocabulary that defines a set different possible event-related occurrences. The technique displays a visual representation of the node structure on the user interface presentation. The technique then compares the expression against one or more sequences of events to find portions of the sequence(s) of events that match the expression, to provide matching sequence information. The technique then generates output information based on the matching sequence information and displays a visual representation of the output information on the user interface presentation.

According to a second aspect, the expression is a regular expression.

According to a third aspect, each sequence of events comprises one or more events, each event specifies zero, one or more attributes, and each attribute corresponds to an attribute-value pair that includes an attribute name (which may be explicit or implicit) and an associated attribute value.

According to a fourth aspect, at least one attribute corresponds to at least one meta-level attribute that applies to two or more events.

According to a fifth aspect, the above-mentioned at least one meta-level attribute includes: a user-related meta-level attribute that describes an end user associated with an event, and/or a session-related meta-level attribute that describes a session associated with an event.

According to a sixth aspect, the receiving operation entails receiving input information in response to a gesture in which a user selects an attribute that is identified in a visualization of output information, the output information in the visualization pertaining to a particular node in the node structure. The defining operation constrains the particular node in response to the gesture.

According to a seventh aspect, the receiving operation entails receiving input information in response to a gesture in which a user selects an attribute that is identified in a visual representation of output information, the output information in the visualization pertaining to a particular node in the node structure. The defining operation creates a new node, that is different from the particular node, in response to the gesture.

According to an eighth aspect, the input information specifies: a position of each node in a display space provided by the user interface presentation; zero, one or more attributes associated with each node; and a quantifier value that describes a number of times that each node is permitted to match an event within the event sequence(s).

According to a ninth aspect, the node structure includes at least two nodes. Further, the input information specifies a manner in which the nodes are connected together.

According to a tenth aspect, a connection of nodes in series defines a conjunctive concatenation of corresponding components in the expression.

According to an eleventh aspect, a collection of node branches in parallel defines a disjunctive combination of corresponding components in the expression, associated with those corresponding node branches.

According to a twelfth aspect, the node branches (with respect to the eleventh aspect) have respective positions with respect to a particular direction in a space defined by the user interface presentation. The position of each node branch along the particular direction defines the priority of the node branch relative to the other node branches. Further, an event that matches plural of the node branches is reported as matching the node branch that has a highest priority among the collection of node branches.

According to a thirteenth aspect, the input information further specifies a binding between at least a first node and a second node, the binding indicating that actions performed by the first node and the second node are applied to a same set of attributes.

According to a fourteenth aspect, the technique may involve forming a group associated with two or more nodes. The group thereafter defines a single logical entity (or unit) that is combinable with other any other node or nodes.

According to a fifteenth aspect, the generating operation (referred to in the first aspect) entails generating a visualization that describes occurrences of an attribute in the matching sequence information, with respect to different values of that attribute.

According to a sixteenth aspect, the generating operation entails generating the output information with respect to a specified matching level. The specified matching level corresponds to one of: an event-level matching level, in which the output information specifies individual event portions which match the expression; or a session-level matching level, in which the output information specifies individual sessions having event portions which match the expression; or a user-level matching level, in which the output information specifies end users who are associated with event portions which match the expression.

According to a seventeenth aspect, the generating operation entails generating information that is based on a consideration on time information associated with at least one event relative to time information associated with at least one other event.

According to an eighteenth aspect, the generating operation further entails filtering initial output information based on at least one filtering factor to generate processed output information. In that scenario, the visualization of the output information that is produced is based on the processed output information.

According to a nineteenth aspect, another technique is described herein for exploring sequences. The technique entails receiving input information in response to at least one user's interaction with a user interface presentation provided by a display output mechanism. The technique then defines a node structure having one or more nodes based an interpretation of the input information. Each node corresponds to a component of a regular expression, and each component is expressed using a vocabulary that defines a set different possible event-related occurrences. The expression as a whole corresponds to a finite state machine. The technique then compares the regular expression against one or more sequences of items to find portions of the sequence(s) of items that match the regular expression, to provide matching sequence information. The technique then generates output information based on the matching sequence information.

A twentieth aspect corresponds to any combination (e.g., any permutation or subset) of the above-referenced first through nineteenth aspects.

According to a twenty-first aspect, one or more computing devices are provided for implementing any of the first through twentieth aspects.

According to a twenty-second aspect, one or more computer-readable storage mediums are provided that include logic that is configured to implement any of the first through twentieth aspects.

According to a twenty-third aspect, one or more means are provided for implementing any of the first through twentieth aspects.

Also described herein is one or more computing devices for facilitating the investigation of event sequences. The device(s) include a display output mechanism on which a user interface presentation is displayed, together with at least one input mechanism for allowing a user to interact with the user interface presentation. The device(s) further include an interpretation module configured to: receive input information, in response to interaction by at least one user with the user interface presentation using the input mechanism(s); and define a node structure having one or more nodes based an interpretation of the input information, each node corresponding to a component of an expression in a pattern-matching language, and each component being expressed using a vocabulary that defines a set different possible event-related occurrences. The expression as a whole corresponds to a finite state machine. The device(s) also include a pattern search module configured to compare the expression against one or more sequences of events to find portions of the sequence(s) of events that match the expression, to provide matching sequence information. The device(s) include a data store for storing the matching sequence information. The device(s) also include a presentation generation module configured to: display a visual representation of the node structure on the user interface presentation; and generate and display output information based on the matching sequence information.

C. Representative Computing Functionality

FIG. 23 shows computing functionality 2302 that can be used to implement any aspect of the environment 102 of FIG. 1, including the SEM 108 of FIG. 5. For instance, the type of computing functionality 2302 shown in FIG. 23 may correspond to functionality provided by the computing device 604 of FIG. 6. In all cases, the computing functionality 2302 represents one or more physical and tangible processing mechanisms.

The computing functionality 2302 can include one or more processing devices 2304, such as one or more central processing units (CPUs), and/or one or more graphical processing units (GPUs), and so on.

The computing functionality 2302 can also include any storage resources 2306 for storing any kind of information, such as code, settings, data, etc. Without limitation, for instance, the storage resources 2306 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 2302. The computing functionality 2302 may perform any of the functions described above when the processing devices 2304 carry out instructions stored in any storage resource or combination of storage resources.

As to terminology, any of the storage resources 2306, or any combination of the storage resources 2306, may be regarded as a computer readable medium. In many cases, a computer readable medium represents some form of physical and tangible entity. The term computer readable medium also encompasses propagated signals, e.g., transmitted or received via physical conduit and/or air or other wireless medium, etc. However, the specific terms “computer readable storage medium,” “computer readable medium device,” and “computer readable hardware unit” expressly exclude propagated signals per se, while including all other forms of computer readable media.

The computing functionality 2302 also includes one or more drive mechanisms 2308 for interacting with any storage resource, such as a hard disk drive mechanism, an optical disk drive mechanism, and so on.

The computing functionality 2302 also includes an input/output module 2310 for receiving various inputs (via input devices 2312), and for providing various outputs (via output devices 2314). Illustrative input devices include a keyboard device, a mouse input device, a touchscreen input device, a digitizing pad, one or more video cameras, one or more depth cameras, a free space gesture recognition mechanism, one or more microphones, a voice recognition mechanism, any movement detection mechanisms (e.g., accelerometers, gyroscopes, magnetometers, etc.), and so on. One particular output mechanism may include a presentation device 2316 and an associated graphical user interface (GUI) 2318. Other output devices include a printer, a model-generating mechanism, a tactile output mechanism, an archival mechanism (for storing output information), and so on. The computing functionality 2302 can also include one or more network interfaces 2320 for exchanging data with other devices via one or more communication conduits 2322. One or more communication buses 2324 communicatively couple the above-described components together.

The communication conduit(s) 2322 can be implemented in any manner, e.g., by a local area network, a wide area network (e.g., the Internet), point-to-point connections, etc., or any combination thereof. The communication conduit(s) 2322 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 2302 can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

More generally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented by one or more computing devices, for exploring event sequences, comprising:
receiving input information in response to interaction by at least one user with a user interface presentation provided by a display output mechanism;
defining a node structure having one or more nodes based an interpretation of the input information, each node corresponding to a component of an expression in a pattern-matching language, and each component being expressed using a vocabulary that defines a set different possible event-related occurrences;
displaying a visual representation of the node structure on the user interface presentation;
comparing the expression against one or more sequences of events to find portions of said one or more sequences of events that match the expression, to provide matching sequence information;
generating output information based on the matching sequence information; and
displaying a visual representation of the output information on the user interface presentation.

2. The method of claim 1, wherein the expression is a regular expression.

3. The method of claim 1,
wherein each sequence of events comprises one or more events,
wherein each event specifies zero, one or more attributes, and
wherein each attribute corresponds to an attribute-value pair that includes an attribute name and an associated attribute value.

4. The method of claim 3, wherein at least one attribute corresponds to at least one meta-level attribute that applies to two or more events.

5. The method of claim 4, wherein said at least one meta-level attribute includes:
a user-related meta-level attribute that describes an end user associated with an event; and
a session-related meta-level attribute that describes a session associated with an event.

6. The method of claim 1,
wherein said receiving comprises receiving input information in response to a gesture in which a user selects an attribute that is identified in a visualization of output information, the output information in the visualization pertaining to a particular node in the node structure; and
wherein said defining constrains the particular node in response to the gesture.

7. The method of claim 1,
wherein said receiving comprises receiving input information in response to a gesture in which a user selects an attribute that is identified in a visual representation of output information, the output information in the visualization pertaining to a particular node in the node structure, and
wherein said defining creates a new node, that is different from the particular node, in response to the gesture.

8. The method of claim 1, wherein the input information specifies:
a position of each node in a display space provided by the user interface presentation;
zero, one or more attributes associated with each node; and
a quantifier value that describes a number of times that each node is permitted to match an event within said one or more event sequences.

9. The method of claim 1,
wherein said one or more nodes includes at least two nodes, and
wherein the input information specifies a manner in which said at least two nodes are connected together.

10. The method of claim 9, wherein a connection of nodes in series defines a conjunctive concatenation of corresponding components in the expression.

11. The method of claim 9, wherein a collection of node branches in parallel defines a disjunctive combination of corresponding components in the expression, associated with those corresponding node branches.

12. The method of claim 11,
wherein the node branches have respective positions with respect to a particular direction in a space defined by the user interface presentation,
wherein the position of each node branch along the particular direction defines a priority of the node branch relative to the other node branches,
wherein an event portion that matches plural of the node branches is reported as matching the node branch that has a highest priority among the collection of node branches.

13. The method of claim 1, wherein the input information specifies a binding between at least a first node and a second node, the binding indicating that actions performed by the first node and the second node are applied to a same set of attributes.

14. The method of claim 1, further comprising forming a group associated with two or more nodes, the group thereafter defining a single logical unit that is combinable with other any other node or nodes.

15. The method of claim 1, wherein said generating of the output information comprises generating a visualization that describes occurrences of an attribute in the matching sequence information, with respect to different values of that attribute.

16. The method of claim 1,
wherein said generating of the output information comprises generating the output information with respect to a specified matching level, and
wherein the specified matching level corresponds to one of:
an event-level matching level, in which the output information specifies individual event portions which match the expression; or
a session-level matching level, in which the output information specifies individual sessions having event portions which match the expression; or
a user-level matching level, in which the output information specifies end users who are associated with event portions which match the expression.

17. The method of claim 1, wherein said generating of the output information comprises generating information that is based on a consideration of time information associated with at least one event relative to time information associated with at least one other event.

18. The method of claim 1,
wherein said generating of the output information further comprises filtering initial output information based on at least one filtering factor to generate processed output information, and
wherein the visualization of the output information is based on the processed output information.

19. One or more computing devices for facilitating investigation of event sequences, comprising:
a display output mechanism on which a user interface presentation is displayed;
at least one input mechanism for allowing a user to interact with the user interface presentation;
an input interpretation module configured to:
receive input information in response to interaction by at least one user with the user interface presentation using said at least one input mechanism; and
define a node structure having one or more nodes based an interpretation of the input information,
each node corresponding to a component of an expression in a pattern-matching language, and each component being expressed using a vocabulary that defines a set different possible event-related occurrences, and
the expression as a whole corresponding to a finite state machine;
a pattern search module configured to compare the expression against one or more sequences of events to find portions of said one or more sequences of events that match the expression, to provide matching sequence information;
a data store for storing the matching sequence information; and
a presentation generation module configured to:
display a visual representation of the node structure on the user interface presentation; and
generate and display output information based on the matching sequence information.

20. A computer readable storage medium for storing computer readable instructions, the computer readable instructions implementing a sequence exploration module when executed by one or more processing devices, the computer readable instructions comprising:
logic configured to receive input information in response to interaction by at least one user with a user interface presentation provided by a display output mechanism;
logic configured to define a node structure having one or more nodes based an interpretation of the input information, each node corresponding to a component of a regular expression, and each component being expressed using a vocabulary that defines a set different possible event-related occurrences;
logic configured to compare the regular expression against one or more sequences of items to find portions of said one or more sequences of items that match the regular expression, to provide matching sequence information; and
logic configured to generate output information based on the matching sequence information.
